(19) United States
(12) Patent Application Publication
(10) Pub. No.: US 2024/0143801 A1
(43) Pub. Date: May 2, 2024

(54) Vehicle Computing System STS Communications with a Personal Computing Device and Applications Thereof

(71) Applicant: SigmaSense, LLC., Wilmington, DE (US)

(72) Inventors: Richard Stuart Seger, JR., Belton, TX (US); Michael Shawn Gray, Elgin, TX (US); Daniel Keith Van Ostrand, Leander, TX (US); Timothy W. Markison, Mesa, AZ (US)

(73) Assignee: SigmaSense, LLC., Wilmington, DE (US)

(21) Appl. No.: 17/975,118

(22) Filed: Oct. 27, 2022

(51) Int. Cl. G06F 21/60

(52) U.S. Cl. CPC G06F 21/606

(57) ABSTRACT

A method for execution by a vehicle computing system includes establishing a screen-to-screen (STS) communication link with a personal computing device. The method further includes detecting a requested operation of the personal computing device. The method further includes determining whether the requested operation is allowed based on one or more of: operational status of the vehicle, a type of the requested operation, and targeted vehicle occupant. The method further includes, when the requested operation is allowed, establishing one or more of: one or more inbound STS channels for inbound STS signals and one or more outbound STS channels for outbound STS signals. The method further includes facilitating the requested operation via the one or more of: the one or more inbound STS channels and the one or more outbound STS channels.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This invention relates generally to data communications and more particularly to data communications between screens.

### Description of Related Art

A computing device is known to communicate data, process data, and/or store data. The computing device may be a cellular phone, a laptop, a tablet, a personal computer (PC), a workstation, a video game device, a server, and/or a data center that support millions of web searches, stock trades, or on-line purchases every hour.

A computing device may also transmit data to another computing device via a near proximity communication. For example, a computing device may use near field communication (NFC), infrared (IR), and/or Bluetooth (BT) to communicate data over short distances. In some examples, the use of near proximity communications are utilized for point-of-sale (POS) transactions and other data communications where security of the data is desired.

### BRIEF DESCRIPTION OF THE SEVERAL VIEWS OF THE DRAWING(S)

FIG. 1 is a schematic block diagram of an example of a vehicle cockpit;

FIG. 2 is a schematic block diagram of an example of screen to screen data communications between a vehicle computing system and a personal computing device;

FIG. 3 is a schematic block diagram of an embodiment of a personal computing device;

FIG. 4 is a schematic block diagram of an example of operation of an embodiment of a vehicle computing system;

FIG. 5 is a schematic block diagram of another example of operation of an embodiment of a vehicle computing system;

FIG. 6 is a schematic block diagram of an example of screen to screen data communications;

FIG. 7 is a schematic block diagram of an example of e-field signaling as used in screen to screen data communications;

FIG. 8 is a logic diagram of an example of a method for a vehicle computing system to support screen to screen data communications;

FIG. 9 is a schematic block diagram of another example of screen to screen data communications;

FIG. 10 is a logic diagram of another example of a method for a vehicle computing system to support screen to screen data communications;

FIG. 11 is a schematic block diagram of an example of allowable data communications within a vehicle cockpit based on occupant position;

FIG. 12 is a logic diagram of another example of a method for a vehicle computing system to support screen to screen data communications;

FIG. 13 is a logic diagram of an example of a method for a personal computing device to support screen to screen data communications;

FIG. 14 is a logic diagram of another example of a method for a personal computing device to support screen to screen data communications;

FIG. 15 is a logic diagram of another example of a method for a personal computing device to support screen to screen data communications;

FIG. 16 is a logic diagram of another example of a method for a personal computing device to support screen to screen data communications;

FIG. 17 is a logic diagram of another example of a method for a personal computing device to support screen to screen data communications;

FIG. 18 is a logic diagram of another example of a method for a personal computing device to support screen to screen data communications;

FIG. 19 is a logic diagram of another example of a method for a personal computing device to support screen to screen data communications;

FIG. 20 is a schematic block diagram of an example of incoming data processing to produce screen-to-screen (STS) formatted inbound signals;

FIG. 21 is a schematic block diagram of an example of outgoing data processing from screen-to-screen (STS) formatted outbound signals;

FIG. 22 is a schematic block diagram of an embodiment of a digital to screen-to-screen (STS) converter;

FIG. 23 is a schematic block diagram of an embodiment of a signal generator of a digital to screen-to-screen (STS) converter;

FIG. 24 is a schematic block diagram of an embodiment of a screen-to-screen (STS) to digital converter;

FIG. 25 is a schematic block diagram of an example of incoming audio data processing to produce screen-to-screen (STS) formatted inbound signals;

FIG. 26 is a schematic block diagram of an example of incoming video and/or graphics data processing to produce screen-to-screen (STS) formatted inbound signals;

FIG. 27 is a schematic block diagram of an example of outgoing audio data processing from screen-to-screen (STS) formatted outbound signals;

FIG. 28 is a schematic block diagram of an example of outgoing video and/or graphics data processing from screen-to-screen (STS) formatted outbound signals;

FIG. 29A is a schematic block diagram of an example of screen-to-screen (STS) communications between a vehicle computing system and a personal computing device regarding an incoming call;

FIG. 29B is a logic diagram of an example of a method for screen-to-screen (STS) communications between a vehicle computing system and a personal computing device regarding an incoming call;

FIG. 30A is a schematic block diagram of an example of screen-to-screen (STS) communications between a vehicle computing system and a personal computing device regarding an outgoing call;

FIG. 30B is a logic diagram of an example of a method for screen-to-screen (STS) communications between a vehicle computing system and a personal computing device regarding an outgoing call;

FIG. 31A is a schematic block diagram of an example of screen-to-screen (STS) communications between a vehicle computing system and a personal computing device supporting an incoming and/or an outgoing call;

FIGS. 31B-31E are logic diagrams of examples of methods for supporting screen-to-screen (STS) communications between a vehicle computing system and a personal computing device regarding an incoming call and/or an outgoing call;

FIG. 32A is a schematic block diagram of an example of screen-to-screen (STS) communications between a vehicle computing system and a personal computing device regarding an incoming text;

FIG. 32B is a logic diagram of an example of a method for screen-to-screen (STS) communications between a vehicle computing system and a personal computing device regarding an incoming text;

FIG. 33A is a schematic block diagram of an example of screen-to-screen (STS) communications between a vehicle computing system and a personal computing device regarding an outgoing text;

FIG. 33B is a logic diagram of an example of a method for screen-to-screen (STS) communications between a vehicle computing system and a personal computing device regarding an outgoing text;

FIG. 34A is a schematic block diagram of an example of screen-to-screen (STS) communications between a vehicle computing system and a personal computing device regarding an outgoing internet search request;

FIG. 34B is a logic diagram of an example of a method for screen-to-screen (STS) communications between a vehicle computing system and a personal computing device regarding an outgoing internet search request;

FIG. 35A is a schematic block diagram of an example of screen-to-screen (STS) communications between a vehicle computing system and a personal computing device regarding an outgoing navigation function request;

FIG. 35B is a logic diagram of an example of a method for screen-to-screen (STS) communications between a vehicle computing system and a personal computing device regarding an outgoing navigation function request;

FIG. 36A is a schematic block diagram of an example of screen-to-screen (STS) communications between a vehicle computing system and a personal computing device regarding a music playback request;

FIG. 36B is a logic diagram of an example of a method for screen-to-screen (STS) communications between a vehicle computing system and a personal computing device regarding a music playback request;

FIG. 37A is a schematic block diagram of an example of screen-to-screen (STS) communications between a vehicle computing system and a personal computing device regarding a video playback request; and

FIG. 37B is a logic diagram of an example of a method for screen-to-screen (STS) communications between a vehicle computing system and a personal computing device regarding a video playback request.

### DETAILED DESCRIPTION OF THE INVENTION

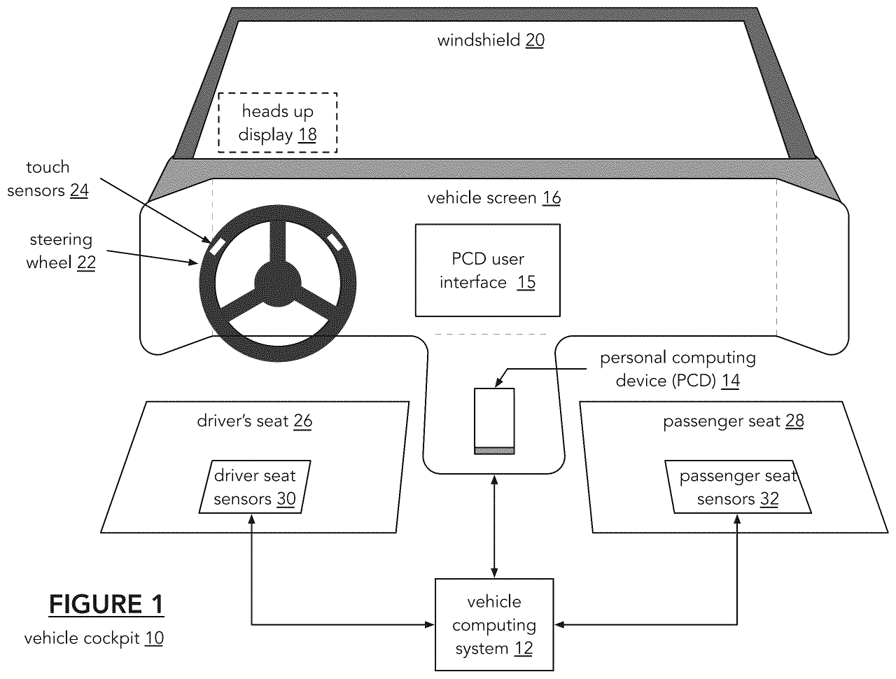

FIG. 1 is a schematic block diagram of an example of a vehicle cockpit 10 that includes a vehicle computing system (VCS) 12, which can communication with a personal computing device (PCD) 14 via screen-to-screen (STS) data communications. The vehicle cockpit 10 further includes a vehicle screen 16, a heads-up display 18 (which appears on windshield 20), a steering wheel 22, touch sensors 24 on the steering wheel, a driver's seat 26 (which includes driver seat sensors 30), and a passenger seat 28 (which includes passenger seat sensors 30).

The vehicle screen 16 may be implemented in a variety of ways. For example, the vehicle screen 16 is a touch display screen that spans a majority of the dashboard for the vehicle (e.g., car, truck, boat, motorcycle, train, airplane, etc.) and extends into the console area (e.g., the area between the driver's seat and the passenger's seat). As another example, the vehicle screen 16 includes one or more video-graphics display areas (which may or may not include touch sensors) and one or more touch areas (e.g., includes one or more touch sensors and may include graphics to indicate a function of a particular touch area and/or of a particular touch sensor).

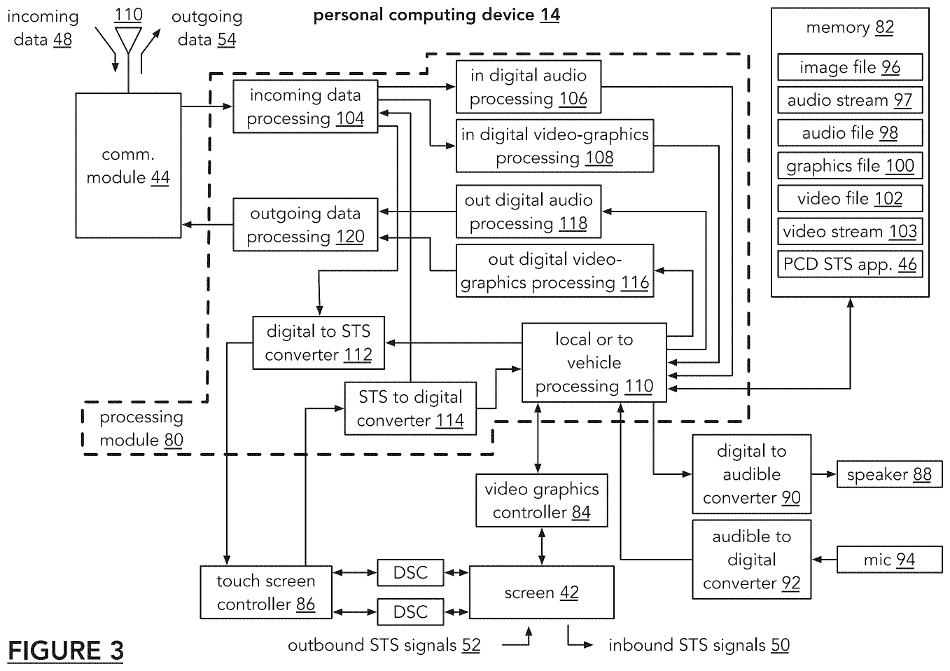

The personal computing device 14 is one of a variety of computing devices. For example, the personal computing device is a cell phone. As another example, the personal computing device 14 is a tablet. As a further example, the personal computing device 14 is a handheld video game unit. As a still further example, the personal computing device 14 is a game console. In general, the personal computing device 14 is a device that includes at least some of the components of the personal computing device 14 of FIG. 3.

The driver seat sensors 30 detect the physical presence of a person in the driver's seat. Similarly, the passenger seat sensors 32 detect the physical presence of a person in the passenger's seat. In addition, the sensors 30 and 32 provide identifying signals to the respective seats such that, when the driver or passenger touches a touch screen display, a touch area, and/or a touch sensor 24, the vehicle computing system 12 determines which vehicle occupant is touching a touch sensor and determines whether such a function should be allowed based on the occupant's position in the vehicle. For a more detailed discussion of occupant sensing, see co-pending patent application entitled “Vehicle Sensor System” filed on Sep. 23, 2021, and having an application number of Ser. No. 17/448,633, which is incorporated herein by reference in its entirety and made part of the present U.S. Utility patent application for all purposes.

When the personal computing device 14 is in the vehicle and in close proximity to a portion of the vehicle screen 16, the vehicle computing system 12 establishes screen-to-screen (STS) communication with the personal computing device 14. For example, when the personal computing device 14 is placed in a designated area of the vehicle screen 16, the STS communication is established. As another example, when the personal computing device 14 on the person of the driver (e.g., in the driver's pocket), the vehicle computing device establishes STS communication via the vehicle screen 16 and/or via the driver seat sensors 30. As another example, when the personal computing device 14 in on the person of the passenger (e.g., in the passenger's pocket), the vehicle computing device establishes STS communication via the vehicle screen 16 and/or via the passenger seat sensors 32.

When the STS communication with the personal computing device 14 is established, the vehicle computing system 12 can control access to the personal computing device 14 in general and further based on occupants' position in the vehicle. For example, the vehicle computing system 14 generates a personal computing device (PCD) user interface 15 on the vehicle screen 16 and/or in the heads-up display 18. The PCD user interface 15 is accessible by the occupants via touch sensors in the vehicle screen 16 and/or via the touch sensors 24 on the steering wheel 22.

In an embodiment, the STS communication is a priority communication mechanism that enables the vehicle computing system 12 to control access and use of the personal computing device 14 while it is within the vehicle. In this regard, STS communications can be customized to the operating system of the vehicle computing system and users can be provided with an application to install on their personal computing devices. This eliminates the need for Bluetooth and/or near-field communications (NFC) between the personal computing device 14 and the vehicle computing system 12; eliminates the need to repeatedly update Bluetooth software and/or NFC software; and eliminates compatibility issues between different software version updates.

As such, the vehicle manufacturer now owns and controls the interfacing between personal computing devices 14 (e.g., cell phones) and the vehicle computing system 12. In addition, STS communication is based on e-field signal coupling making it a short distance communication channel, which adds to security of the personal computing device 14 and/or to the security of the vehicle computing system 12. Security is further increased by the proprietary nature of STS communications and the unique encoding of the data being conveyed via the STS communications.

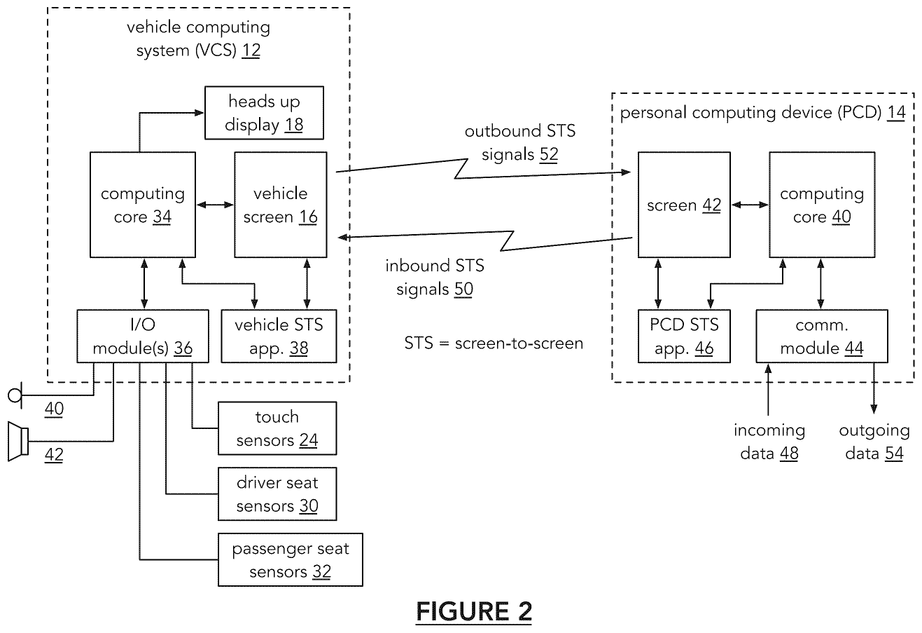

FIG. 2 is a schematic block diagram of an example of screen to screen data communications between a vehicle computing system (VCS) 12 and a personal computing device (PCD) 14. The vehicle computing system 12 includes a computing core 34, the heads-up display 18, the vehicle screen 16, input/output (I/O) modules 36, and a vehicle STS application 38 (which is stored in memory). The vehicle computing system 12 is coupled to one or more microphones 40, one or more speakers 42, the touch sensors 24 on the steering wheel, the driver seat sensors 30, and the passenger seat sensors 32.

The personal computing device 14 includes a screen 42, a computing core 40, a communication module 44, and a PCD STS application 46. The communication module 44 facilitates receiving inbound data 48 and transmitting outgoing data 54. The communication module 44 includes one or more of a cellular voice radio frequency (RF) transceiver and baseband processing; a cellular data RF transceiver and baseband processing; a Bluetooth RF transceiver and baseband processing; a Global Positioning Satellite (GPS) transceiver and baseband processing; an NFC transceiver and baseband processing; and/or a satellite transceiver and baseband processing.

For each of the vehicle computing system 12 and the personal computing device 14, each computing core 34 and 42 includes one or more of: a core control module, a processing module, main memory, read only memory, a peripheral interface control module, external memory interface module, a network interface module, cloud memory interface module, cloud processing interface module, and/or a video graphics processing module.

Each of the screens 16 and 42 at least partially include one or more touch sensors. For example, a touch screen display, which comprises at least a portion of the screen 16 or 42, includes electrodes as touch sensors. As another example, a portion of the screen includes a graphics overlay for one or more capacitive sensors. As yet another example, a portion of the screen includes one or more capacitive sensors (e.g., no video or graphics).

In general, when the personal computing device 14 and the vehicle computing system 12 are coupled via STS communications, the vehicle acts the user input interface and user output interface for the personal computing device. For instance, the personal computing device 14 processes one or more operations from a non-exhaustive list of: incoming and outgoing voice cellular calls, incoming and outgoing data cellular calls, incoming and outgoing text messages, navigation functions, internet search functions, stored music playback requests, streaming music playback requests, stored video playback requests, streaming video playback requests, and/or video games play.

For an operation, the personal computing device 14 receives incoming data 48 (e.g., an incoming RF voice cellular signal) via the communication module 44. The communication module 44 converts in the incoming data 48 into inbound data signals (e.g., digitized voice signals) that are processed by the computing core 40. When coupled to the vehicle computing system 12, the computing core 40 utilizes the PCD STS application 46 to convert the inbound data signals into inbound STS signals 50 that are transmitted via the screen 42 to the vehicle screen 16.

The vehicle computing system 12 utilizes the vehicle STS application 38 to convert the inbound STS signals 50, which were received via the vehicle screen 16, back into the inbound data signals (e.g., digitized voice signals). The computing core 34 processes the recovered inbound data signals and, for audible signals, provides them to the I/O module for presentation on via the speaker 42. If the recovered inbound signals include a video component and/or graphic component, the computing core 34 renders visual data of the video component and/or graphics component. The computing core 34 provides the rendered visual data to a display screen portion of the vehicle screen 16 and/or to the heads-up display 18.

As a continuation of the operation, if the user has a reply to the recovered inbound signals, the vehicle computing system 12 processes the reply. In an example, the reply is a voice response that is received via the microphone 40 and converted into outbound digitized voice signals via the I/O module 36. The computing core 34, utilizing the vehicle STS application 38, convers the outbound digitized voice signals into outbound STS signals 52. The vehicle screen 16 transmits the outbound STS signals 52 to the screen 42 of the personal computing device 14.

In another example, the reply is a text response (e.g., entered text or via a voice to text function) that is received via the microphone 40, a touch sensor 24, and/or a touch portion of the vehicle screen. The computing core 34 converts the text response into outbound digitized text signals and, utilizing the vehicle STS application 38, convers the outbound digitized text signals into outbound STS signals 52. The vehicle screen 16 transmits the outbound STS signals 52 to the screen 42 of the personal computing device 14.

In yet another example, the reply is a video response that is received via the microphone 40 and a camera (not shown). The computing core 34 converts the video response into outbound digitized video signals and, utilizing the vehicle STS application 38, convers the outbound digitized video signals into outbound STS signals 52. The vehicle screen 16 transmits the outbound STS signals 52 to the screen 42 of the personal computing device 14.

In a further example, the reply is a graphics response that is received via selection of graphic options (e.g., an emoji) by a touch sensor 24 and/or by a touch portion of the vehicle screen. The computing core 34 converts the graphics response into outbound digitized graphics signals and, utilizing the vehicle STS application 38, convers the outbound digitized graphics signals into outbound STS signals 52. The vehicle screen 16 transmits the outbound STS signals 52 to the screen 42 of the personal computing device 14.

In a still further example, the reply is an image response (e.g., a picture) that is received via a camera (not shown). The computing core 34 converts the image response into outbound digitized image signals and, utilizing the vehicle STS application 38, convers the outbound digitized images signals into outbound STS signals 52. The vehicle screen 16 transmits the outbound STS signals 52 to the screen 42 of the personal computing device 14.

The computing core 40 of the personal computing device 14, using the PCD STS application 46, converts the outbound STS signals 52 back into outbound digitized data signals (e.g., voice, text, video, graphics, and/or image). The computing core 40 provides the outbound digitized data signals to the communication unit 44. The communication unit 44 converts the outbound digitized data signals into outgoing data 54 in accordance with a corresponding communication protocol (e.g., cellular voice and/or data RF communication protocols).

FIG. 3 is a schematic block diagram of an embodiment of a personal computing device 14 that includes the communication module 44, a processing module 80, memory 82, a video graphics controller 84, a touch screen controller 86, the screen 42, one or more speakers 88, a digital to audible converter 90, an audible to digital converter 92, one or more microphones 94, and a plurality of drive sense circuits (DSC). The memory 82 includes main memory of the computing core 40, external memory coupled to the computing core via a peripheral interface, and/or cloud memory. The main memory of the memory 82, the processing module 80, the video graphics controller 84, the digital to audible converter 90, and the audible to digital converter are included in the computing core 40 of the personal computing device 14.

The processing module 80 is configured to implement an incoming data processing module 104, an inbound digital audio processing module 106, an inbound video-graphics processing module 108, a local or to vehicle processing module 110, a digital to STS (screen-to-screen) converter 112, an STS to digital converter 114, an outbound digital video-graphics processing module 116, an outbound digital audio processing module 118, and an outgoing data processing module 120.

The memory 82 stores one or more image files 96, one or more audio files 98, one or more graphics files 110, one or more video files 102, and the PCD STS application 46. As used herein, a file is data regarding one or more of a document, an application, an image, a song, a video clip, a movie, etc. The data of a file includes the content data, meta data, an/or file name data.

The communication module 44 receives incoming data 48 via the antenna 110 as an incoming RF signal that is formatted in accordance with a wireless communication protocol (e.g., cellular voice protocol, cellular data protocol, etc.). The communication module 44 converts in the incoming data 48 into inbound data signals and provides them to the incoming data processing module 104.

The incoming data processing module evaluates the inbound data signals to determine the type of signal (e.g., data, voice, audio, image, video, graphics, text, etc.) and the corresponding data format. For example, the incoming data processing module 104 determines whether a digital audio data is a stereo audio signal, a monotone audio signal, or a multiple channel audio signal. In addition, the incoming data processing module 104 determines whether the data is in a raw data format (e.g., pulse code modulation, WAV, AU), its sample rate (e.g., 44.1 K, 48 K, 96K, or 192K), and its bit depth (e.g., 8 bits, 16 bits, etc.). If the digital audio signal is not in a raw data format, the incoming data processing module 104 determines whether the digital audio data is compressed using a lossy compression technique (e.g., Opus, MP3, AAC, ATRAC, etc.) or a lossless compression technique (e.g., FLAC, WavPack, TTA, etc.).

Having determined the type and corresponding format, the incoming data processing module 104 provides audio type signals (e.g., voice, music, etc.) of the inbound data signals to the inbound digital audio processing module 106 and/or provides visual type signals (e.g., text, graphics, video, images, etc.) of the inbound data signals to the inbound digital video graphics processing module 108.

The inbound digital audio processing module 106 determines whether current format of digital audio signals is the desired format for sending digital audio signals to the vehicle computing system. For example, the desired format is MP3 or WAV. If the digital audio signals are in the desired format, the inbound digital audio processing module 106 provides the digital audio signals to the local or vehicle processing module 116.

If the format is not the desired format, the inbound digital audio processing module 106 converts the current format to the desired format. In an embodiment, the inbound digital audio processing module 106 converts the current format of the digital audio signal into a raw format and then converts the raw format into the desired format. Once converted, the inbound digital audio processing module 106 sends the digital audio signals to the local or to vehicle processing module 110.

The local or to vehicle processing module 110 determines whether the received digital audio signals are to be provided to the digital to STS converter 112 for transmitting to the vehicle or are to be provided to the digital to audible converter 90. In an embodiment, when the local or to the vehicle processing module 110 detects that the personal computing device 14 is coupled to a vehicle computing system via STS communication link, it sends the received digital audio signals to the digital to STS converter 112. When the STS communication link is not detected, the local or to the vehicle processing module 110 sends the digital audio signals to the digital to audible converter 90.

The detection of an STS communication link may be done in a variety of ways. For example, the local or to the vehicle processing module 110 receives a signal for the STS to digital converter 114 that the STS communication link exists. As another example, the local or to the vehicle processing module 110 sends an STS ping signal via the digital to STS converter 112 and, if a ping response is received via the STS to digital converter 114 is received in a given time frame, it determines that the STS communication link exists.

As will be described in greater detail with reference to one or more subsequent figures, the digital to STS converter 112 converts the digital audio signals into inbound STS formatted signals, which are provided to the touch screen controller 86. The touch screen controller 86 processes the inbound STS formatted signals to produce STS drive signals, which are provided to one or more drive sense circuits (DSC). The one or more DSCs drives an electrode or sensor of the screen 42, such that the screen transmits the audio signals as inbound STS signals 50 to the vehicle screen 16.

The inbound digital video-graphics processing module 108 determines whether current format of digital video-graphics signals is the desired format for sending digital video-graphics signals to the vehicle computing system. Video formats include, but are not limited to, GIF, MPEG, QuickTime, Windows Media Video, Flash video, Raw Video Format, etc. Image and/or graphics formats, include, but are not limited to: JPEG, PNG, TIFF, GIF, BMP, AVIF, etc. Text file formats are based on the application and/or operating system of the personal computing device. For example, the desired format for video data is MPEG-4; for image and/or graphics data is PNG.

If the digital video-graphics signals are in the desired format, the inbound digital video-graphics processing module 108 provides the digital audio signals to the local or vehicle processing module 116. If the format is not the desired format, the inbound digital video-graphics processing module 108 converts the current format to the desired format. In an embodiment, the inbound digital video-graphics processing module 108 converts the current format of the digital video-graphics signal into a raw format and then converts the raw format into the desired format. Once converted, the inbound digital video-graphics processing module 108 sends the digital video-graphics signals to the local or to vehicle processing module 110.

The local or to vehicle processing module 110 determines whether the received digital video-graphics signals are to be provided to the digital to STS converter 112 for transmitting to the vehicle or are to be provided to the video graphics controller 84. In an embodiment, when the local or to the vehicle processing module 110 detects that the personal computing device 14 is coupled to a vehicle computing system via STS communication link, it sends the received digital video-graphics signals to the digital to STS converter 112. When the STS communication link is not detected, the local or to the vehicle processing module 110 sends the digital video-graphics signals to the video graphics controller 84, which converts the digital video-graphics signals into visual data signals for display on the screen 42.

When the STS communication link exists between the personal computing device 14 and the vehicle computing system, the screen 42 receives outbound STS signals from the vehicle screen. Note that the inbound STS signals 50 and the outbound STS signals 52 are from the vehicles point of view.

The drive sense circuits (DSC) sense the outbound STS signals being received by the screen 42 and provide sensed indications of the STS signals to the touch screen controller 86. The touch screen controller 86 generates STS formatted outbound signals from the sensed indications and provides them to the STS to digital converter 114. The converter 114 converts the STS formatted outbound signals into digital audio signals having the desired audio format and/or digital video-graphics signals having the desired video-graphics format.

The STS to digital converter 114 sends the digital audio signals having the desired audio format to the outbound digital audio processing module 118 directly or via the local or to vehicle processing module 110. The STS to digital converter 114 sends the digital video-graphics signals having the desired video-graphics format to the outbound digital video-graphics processing module 116 directly or via the local or to vehicle processing module 110.

The outbound digital audio processing module 118 receives the digital audio signals having the desired audio format and determines whether to change the audio format. If so, the outbound digital audio processing module 118 converts (e.g., represent the same or nearly the same audio data in a different digital way) the audio format of the digital audio signals into outbound digital audio signals in a desired outgoing format. The outbound digital audio processing module 118 sends the outbound digital audio signals in a desired outgoing format (if changed) or the received digital audio signals (if unchanged) to the outgoing data processing module 120.

The outbound digital video-graphics processing module 116 receives the video-graphics signals having the desired video-graphics format and determines whether to change the video-graphics format. If so, the outbound digital video-graphics processing module 116 converts (e.g., represent the same or nearly the same video-graphics data in a different digital way) the video-graphics format of the digital video-graphics signals into outbound digital video-graphics signals in a desired outgoing format. The outbound digital video-graphics processing module 116 sends the outbound digital video-graphics signals in a desired outgoing format (if changed) or the received digital video-graphics signals (if unchanged) to the outgoing data processing module 120.

The outgoing data processing module 120 prepares the outbound digital audio signals and/or outbound digital video-graphics signals for transmission via the communication module 44. For example, the outgoing data processing module 120 combines (e.g., aggregates, interlaces, concatenate, etc.) the outbound digital audio signals and/or outbound digital video-graphics signals into outgoing signals. As another example, the outbound data processing module 120 compresses the outbound digital audio signals and/or outbound digital video-graphics signals to produced compressed outbound digital audio signals and/or compressed outbound digital video-graphics signals that are then provided to the communication module 44 as outgoing signals.

As another example, the outbound data processing module 120 encrypts the outbound digital audio signals and/or outbound digital video-graphics signals to produced encrypted outbound digital audio signals and/or encrypted outbound digital video-graphics signals that are then provided to the communication module 44 as outgoing signals. The communication module 44 processes the outgoing signals to produce and transmit the outgoing data 54.

The incoming data processing module 104 is further operable to detect incoming calls, incoming texts, and/or other incoming operations. When the incoming data processing module 104 receives an incoming call request, an incoming text, and/or an incoming request for another operation, it generates a notice message of an incoming operation. The incoming data processing module 104 sends the notice message to the digital to STS converter 112.

The digital to STS converter 112 converts the notice message into an STS formatted notice signal and sends it to the touch screen controller 86. The touch screen controller 86 generates a reference signal to include the STS formatted notice signal and provides the reference signal to one or more drive sense circuits (DSC). The DSC(s) drives the reference signal on one or more electrodes or sensors of the screen 42, which radiates the inbound STS signals 50 represented the notice message of an incoming operation.

The screen receives a response to the notice of an incoming operation via outbound STS signals 52. The DSC sense the embedded response in the outbound STS signals 52 and provides the sensed signal to the touch screen controller 86. The touch screen controller 86 forwards the sensed signal of the response to the STS to digital converter 114. The STS to digital converter 114 recovers the response message and provides it to the incoming data processing module 104.

The incoming data processing module 104 processes the incoming operation based on the response message. When the response message is to accept the incoming operation, the incoming data processing module 104 informs the communication module 44 to accept the incoming data 48 and process it. When the response message is to reject the incoming operation, the incoming data processing module 104 informs the communication module 44 to reject the incoming operation. When the response message is to store content of the incoming operation (e.g., store a text message, send a voice call to voice mail, etc.), the incoming data processing module 104 informs the communication module 44 to store the content of the incoming operation.

In another mode of operation, the personal computing device 14 receives a request from the vehicle for playback of a stored audio file (e.g., music, a voice mail, etc.) or playback of a stored video-graphics file (e.g., a movie, a video, an image, a graphics image, etc.). In this instance, the screen 42 receives outbound STS signals 52 that include a message for playback of a particular file. One or more drive sense circuits (DSC) sense signals regarding the playback message and provides the sensed signals to the STS to digital converter 114 via the touch screen controller 86.

The STS to digital converter 114 recovers the playback message from the sensed signals and provides the message to the local or to vehicle processing module 110. The local or to vehicle processing module 110 processes the playback message to identify the requested file (image file 96, audio file 98, graphics file 100, video file 102, etc.) and to read the file from memory. As the file is read from memory, the local or to vehicle processing module 110 provides the read data to the digital to STS converter 112 for transmission to the vehicle.

In another mode of operation, the personal computing device 14 receives a request from the vehicle for playback of a streaming audio data (e.g., music, podcast, etc.) or playback of a stream video-graphics data (e.g., a movie, a video, a video-cast, etc.). In this instance, the screen 42 receives outbound STS signals 52 that include a message for playback of particular streaming data. One or more drive sense circuits (DSC) sense signals regarding the playback message and provides the sensed signals to the STS to digital converter 114 via the touch screen controller 86.

The STS to digital converter 114 recovers the playback message from the sensed signals and provides the message to the local or to vehicle processing module 110. The local or to vehicle processing module 110 processes the playback message to identify the requested streaming data and engages a corresponding application (streaming audio app 97, a podcast app, streaming video app, etc.). As the application produces playback data, the local or to vehicle processing module 110 sends it to the digital to STS converter 112 for transmission to the vehicle.

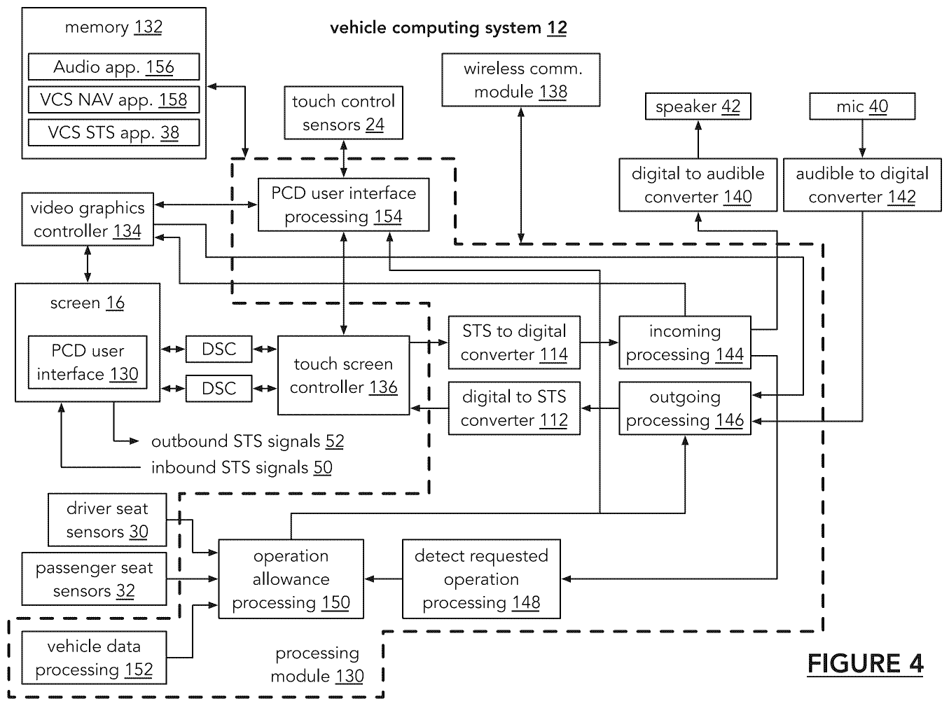

FIG. 4 is a schematic block diagram of an example of a vehicle computing system 12 processing incoming operations. The vehicle computing system 12 includes the screen 16, the touch control sensors 24, driver seat sensors 30, passenger seat sensors 32, one or more microphones 40, an audible to digital converter 142 (e.g., an amplifier followed by an ADC), one or more speakers 42, a digital to audible converter 140 (e.g., a DAC followed by a power amplifier), a processing module 130, memory 132, a video graphics controller 134, a touch screen controller 136, drive sense circuits (DSC), and a wireless communication module 138. The processing module 130 is configured to provide a digital to STS converter 112, an STS to digital converter 114, an incoming data processing module 144, an outgoing data processing module 146, a detect requested operation processing module 148, an operation allowance processing module 150, a vehicle data processing module 152, and a PCD (personal computing device) user interface processing module 154.

The memory 132 includes main memory, external memory, and/or cloud storage memory. The memory 132 stores an audio application 156 (e.g., an audio file playback application or a steaming audio application), a vehicle computing system (VCS) navigation (NAV) application 158, and the VCS STS application 38.

For an incoming operation (e.g., incoming call, incoming text, etc.) the screen 16 receives inbound STS signals 50 from a personal computing device 14. The inbound STS signals 50 include a notice of the incoming operation, a source of the incoming operation, and/or other information regarding the incoming operation. One or more drive sense circuits (DSC) senses the STS signaling received by the screen 16 and produces sensed signals therefrom. The DSC(s) provides the sensed signals to the touch screen controller 136, which provides a representation of the sensed signals (e.g., the signals themselves, a coded version of the signals, an impedance value, a capacitance value, etc.) to the STS to digital converter 114.

The STS to digital converter 114 recovers the messaging of the incoming operation and provides it to the incoming processing module 144. The incoming processing module 144 recognizes that the data received is a message regarding an incoming operation and sends it to the detect requested operation processing module 148.

The detect requested operation processing module 148 interprets the message regarding the incoming operation to determine the type of operation (e.g., an incoming call, an incoming text, etc.), a source of the requested operation (e.g., source of the call, source of the text, etc.), the destination of the operation (e.g., the driver's personal computing device, the passenger's personal computing device, etc.), and/or other information regarding the incoming operation request. The detect requested operation processing module 148 provides this information to the operation allowance processing module 150.

In addition to receiving the information regarding the incoming operation request, the operation allowance processing module 150 retrieves driver sensed data from the driver seat sensors 30, passenger sensed data from the passenger seat sensors 32, and/or vehicle operation data from the vehicle data processing module 152. The driver sensed data includes signals to indicate that an occupant is in the driver's seat, signals to identify the driver when engaging a touch function of the screen 16, of the touch sensors 24, and/or other touch sense devices. The passenger sensed data includes signals to indicate that an occupant is in the passenger's seat, signals to identify the passenger when engaging a touch function of the screen 16, of the touch sensors 24, and/or other touch sense devices.

The vehicle data processing module 152 produces a variety of data regarding the operation of the vehicle. For example, the vehicle data processing module 152 produces information regarding movement of the vehicle (e.g., parked, idling, breaking, speed, accelerating, decelerating, engine off, etc.). As another example, the vehicle data processing module 152 produces information regarding driving conditions (e.g., weather conditions, visibility, road conditions, traffic levels, road contours, etc.). As a further example, the vehicle data processing module 152 produces information regarding the driver (e.g., time in the seat, stress level, fatigue level, driving pattern, driving habits, etc.).

The operation allowance processing module 150 utilizes the retrieved data to determine whether the incoming operation should be accepted, rejected, stored by the personal computing device, and/or other response. For example, if the target of the incoming operation is the passenger and the source of the incoming operation request is an allowed source (e.g., on an approved source list or not on an unapproved source list), the operation allowance processing module 150 accepts the incoming operation request.

As another example, if the target of the incoming operation is the driver and the source of the incoming operation request is an allowed source, the operation allowance processing module 150 interprets the other data to decide whether to accept the incoming operation request or not. As a specific example, if the car is parked, then the operation allowance processing module 150 would accept the incoming operation request. As another specific example, if the vehicle is in motion and the weather is inclement, the operation allowance processing module 150 would reject the request or send it to storage of the personal computing device.

Having made a decision, the operation allowance processing module 150 sends the decision to the outgoing processing module 146. For a decision of reject the request or send the requested operation to storage of the personal computing device, the outgoing processing module 150 creates a reject or storage message and provides it to the digital to STS converter 112.

The digital to STS converter 112 formats the reject or storage message in accordance with the STS communication protocol and provides the STS formatted message to the touch screen controller 136. The touch screen controller 136 generates one or more reference signals based on the STS formatted message and sends the reference signal(s) to one or more drive sense circuits (DSC). The DCS(s) drive the reference signal(s) on electrodes or touch sensors of the screen 16. The screen 16 radiates the signals to produce the outbound STS signals 52.

When the operation allowance processing module 150 decides to accept the incoming operation request, it creates an accept message and provides it to the digital to STS converter 112. The digital to STS converter 112, the touch screen controller 136, the DSC(s), and the screen process the accept message to produce outbound STS signals 52.

In addition, the operation allowance processing module 150 sends a create user interface message to the PCD user interface module 154. The create user interface message includes identity of the type of operation, the source of the requested operation, one or more user input interfaces to support the operation, one or more user output interfaces to support the operation, and/or other information the personal computing device would display (visually, in text, audible, and/or otherwise) regarding the operation.

The PCD user interface module 154 creates a PCD user interface 130 in accordance with the create user interface message. For example, for an incoming call, the PCD user interface 130 would include a graphical representation of an incoming call on a cell phone. As another example, for an incoming text, the PCD user interface 130 would include a graphical representation of an incoming text on a cell phone or tablet.

The PCD user interface 130 may be presented in a variety of ways. For example, the PCD user interface 130 is graphical mirror image of the graphical user interface (GUI) that would appear on the personal computing device (e.g., the GUI on a phone for an incoming phone call or for an incoming text). The mirrored GUI is accessible via touch, via the touch sensors 24 on the steering wheel, via voice to text commands, and/or other mechanism.

As another example, the PCD user interface 130 is a custom graphical user interface (GUI) that represents input/output functions of the personal computing device to support the operation. The custom GUI is accessible via touch, via the touch sensors 24 on the steering wheel, via voice to text commands, and/or other mechanism. The PCD user interface 130 is provided on the screen 16, in the heads-up display, and/or other visual location within the vehicle cockpit. When the operation ends, the PCD user interface 130 is removed from the screen 16 and/or heads-up display.

As a further example, the PCD user interface 130 is a custom audible user interface. In this example, the text data received regarding the input/output user interfaces of the personal computing device are converted to audible signals played via the one or more speakers. As yet a further example, the PCD user interface 130 is a combination of visual and audible interface.

When the incoming operation is accepted, the vehicle computing system 12 facilitates the setup, the execution, and the teardown of the incoming operation. The set up includes creating the PCD user interface 130 and further includes establishing one or more inbound STS channels for inbound STS signals regarding the operation and/or one or more outbound STS channels for outbound STS signals regarding the operation. For example, for a voice call, the vehicle computing device 12 creates one or more outbound STS channels for outbound voice signals (e.g., voice signals from an occupant of the vehicle that are to be transmitted by the personal computing device) and creates one or more inbound STS channels for inbound voice signals (e.g., received voice signals by the personal computing device and forward to the vehicle).

For execution of the operation, the vehicle computing system receives incoming signals from the personal computing device via the inbound STS channel(s). For example, an incoming voice signals from the personal computing device are received via the inbound STS channel(s), and processed by the STS to digital converter 114, the incoming processing module 114, the digital to audible converter 140 (which includes text to voice functions), and the speaker(s) 42.

As another example, an incoming video-graphics signals from the personal computing device are received via the inbound STS channel(s), and processed by the STS to digital converter 114, the incoming processing module 114, the digital to audible converter 140, the speaker(s) 42, the video graphics controller 134, and/or the screen 16. For instance, if only audible representations of received signals are allowed, the received video-graphics signals would be rendered, as reasonable as possible, audible and presented via the speaker(s) 42.

In furtherance of executing the operation, the vehicle computing system sends outgoing signal to the personal computing device via the outbound STS channel(s). For example, the microphone 40 generates an audio signal from a received voice sound. The audible to digital converter 142 converts the audio signal into a digital audio signal. The outgoing processing module 146, the digital to STS converter 112, the touch screen controller 136, the DSC(s), and the screen convert the digital audio signal into an outbound STS signal that is conveyed via the outbound STS channel(s).

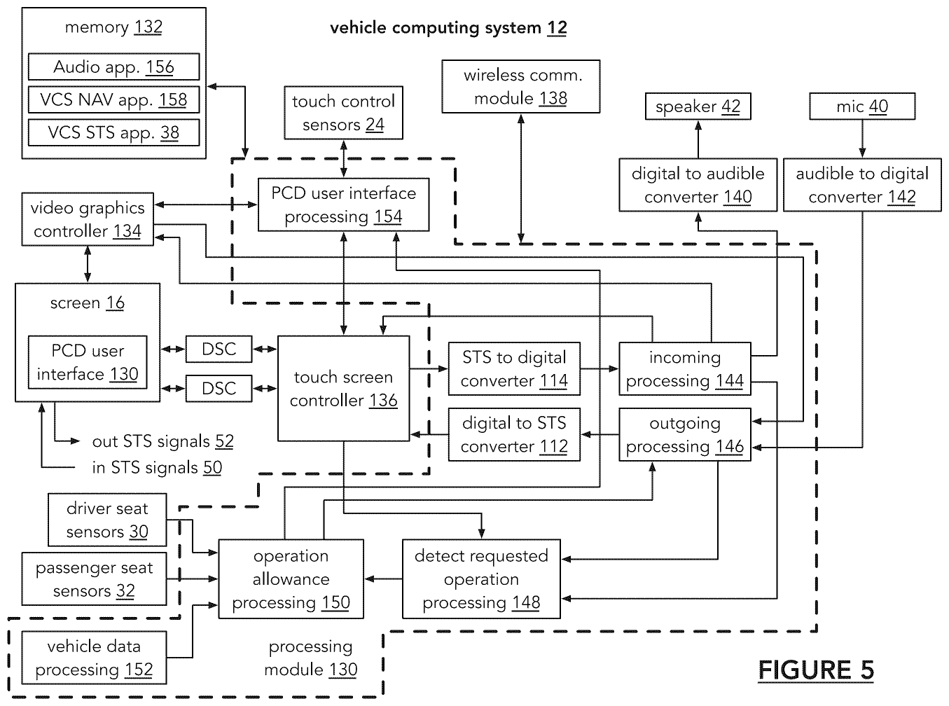

FIG. 5 is a schematic block diagram of another example of a vehicle computing system 12 processing outgoing operations. The vehicle computing system 12 includes the screen 16, the touch control sensors 24, driver seat sensors 30, passenger seat sensors 32, one or more microphones 40, an audible to digital converter 142, one or more speakers 42, a digital to audible converter 140, a processing module 130, memory 132, a video graphics controller 134, a touch screen controller 136, drive sense circuits (DSC), and a wireless communication module 138. The processing module 130 is configured to provide a digital to STS converter 112, an STS to digital converter 114, an incoming data processing module 144, an outgoing data processing module 146, a detect requested operation processing module 148, an operation allowance processing module 150, a vehicle data processing module 152, and a PCD (personal computing device) user interface processing module 154.

The memory 132 includes main memory, external memory, and/or cloud storage memory. The memory 132 stores an audio application 156 (e.g., an audio file playback application or a steaming audio application), a vehicle computing system (VCS) navigation (NAV) application 158, and the VCS STS application 38.

For an outgoing operation, an occupant of the vehicle makes a request for an outgoing operation (e.g., make a cell phone call, send a text, initial an internet search, activate navigation function on the PCD, etc.) to be executed by the personal computing device (PCD). The request is received via an audible command, a touch command received via the screen 16, a touch command received via a touch sensor 24 on the steering wheel, and/or other PCD outgoing operation request user interface mechanism.

For a voice command for an outgoing operation, the microphone 40 receives it, the audible to digital converter 142 converts it into a digital command signal, which is forward to the detect requested operation processing module 148 via the outgoing processing module 146. The detect requested operation processing module 148 interprets the outgoing command signals to determine the type of operation (e.g., an outgoing call, an outgoing text, etc.), a source of the requested operation (e.g., the driver, passenger, etc.), the destination of the operation, and/or other information regarding the outgoing operation request. The detect requested operation processing module 148 provides this information to the operation allowance processing module 150.

In addition to receiving the information regarding the outgoing operation request, the operation allowance processing module 150 retrieves driver sensed data from the driver seat sensors 30, passenger sensed data from the passenger seat sensors 32, and/or vehicle operation data from the vehicle data processing module 152. The operation allowance processing module 150 utilizes the retrieved data to determine whether the outgoing operation should be allowed or rejected.

If the operation allowance processing module 150 determines to reject the outgoing operation request, it generates a rejection message, which is conveyed to the occupants of the vehicle via an audible message and/or a video-graphics message. If the operation allowance processing module 150 determines to reject the outgoing operation request, it generates an allow message and provides it to the outgoing processing module 146 and to the PCD user interface processing module 154.

The outgoing processing module 146 provides the allow message to the digital to STS converter 112, which converts the allow message into an STS formatted message. The touch screen controller 136 generates one or more reference voltages from the STS formatted allow message. One or more DSCs drive the reference voltage(s) on the screen 16, which radiates the outbound STS signals 52.

If the outgoing operation request is accepted by the personal computing device, the screen 16 receives inbound STS signals that contain the personal computing device's acceptance of the outgoing operation request. The DSC(s) senses one or more acceptance signals from the screen 16, which the touch screen controller 136 converts into an STS formatted acceptance message. The STS to digital converter 114 converts the STS formatted acceptance message into an acceptance message and provides the acceptance message to the incoming processing module 144.

The incoming processing module 144 determines a number of inbound STS channels to create and a number of STS outbound channels to create for the outgoing operation. For example, if the outgoing operation is a phone call, the incoming processing module 144 sets up one or more inbound STS channels for incoming voice signals and sets up one or more outbound STS channels for outgoing voice signals.

The number of channels is based on the data rate of the signals and the bandwidth of the channels. For example, the PCM data rate for voice signals is 64 kbps and the per channel bandwidth is 28.8 kbps (e.g., 96 bits at a 300 Hz rate). For this example, 3 channels would be assigned for inbound voice signals and 3 channels would be assigned outbound voice signals. As will be described with reference to one or more subsequent figures, there are a variety of data modulation/demodulation techniques to in the data rate of an STS channel.

Once the inbound STS channels and/or outbound STS channels are established, the vehicle computing system functions as the user input/output interface for operations being executed on by the personal computing device. For example, inbound voice and/or audio signals are provided to the digital to audible converter 140, converted to analog signals and rendered audible via the speaker(s) 42. As another example, outbound voice signals are received by the microphone, converted to digital audio signals via the audible to digital converter 142, and routed by the outbound processing module 146 to the screen for transmission as outbound STS signals 52.

As a further example, inbound video-graphics are provided to the video graphics controller 134, which generates video data therefrom. The video data is then presented on the display 16. As a still further example, outbound video-graphics signals are received by a camera (not shown), converted to digital video-graphics signals, and routed by the outbound processing module 146 to the screen for transmission as outbound STS signals 52.

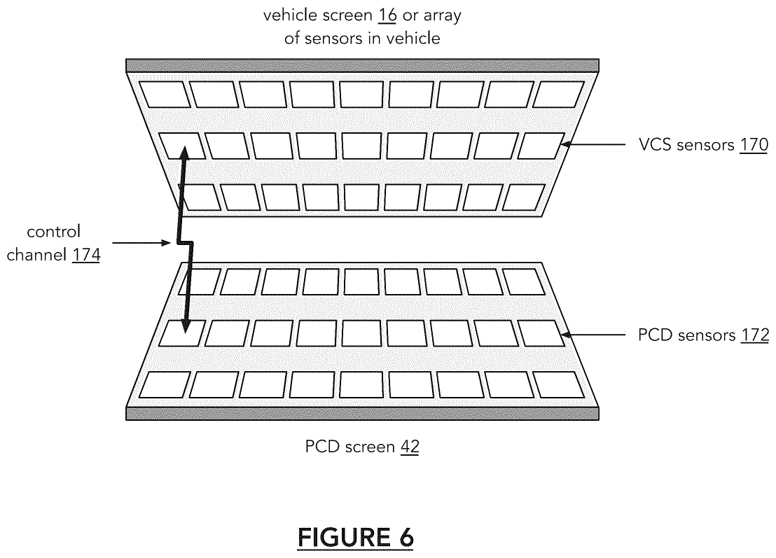

FIG. 6 is a schematic block diagram of an example of screen to screen (STS) data communications. In this example, the vehicle screen 16 includes a plurality of VCS (vehicle computing system) sensors 170 and the PCD (personal computing device) screen 42 includes a plurality of PCD sensors 172. The sensors 170 and 172 may be implemented in a variety of ways.

For example, the sensors 170 and 172 are electrodes of a touch screen display or of a touch surface. Within a touch screen display or touch surface, the electrodes 170 and 172 are arrange in rows and columns on the same layer and/or on different layers. Each electrode has a self-capacitance to a ground reference and each intersection of a row electrode with a column electrode creates a mutual capacitance. In another example, the sensors 170 and 172 are individual capacitor sensors arranged in rows and columns.

Alternatively, the PCD screen 42 is proximal to a grid of sensors located in the driver's seat or in the passenger's seat. The sensors of the grid of sensors are implemented as electrodes arranged in rows and columns or as individual capacitor sensors arranged in rows and columns.

When the PCD screen 42 physically proximal to the VCS screen or the array of sensors in a seat (e.g., within 30 or 40 centimeters), an STS controller channel 174 is established. For example, when the vehicle computing system 12 detects that the PCD screen 42 is physically close to the VCS screen 16 or an array of sensors, the vehicle computing system 12 engages the VCS STS application 38 to create and send an outbound STS signal on one or more of the sensors of the screen 16 or of the array of sensors to the PCD screen 42.

The outbound STS signal is a request to create the control channel. The vehicle computing system and the personal computing device use the control channel 174 to convey notices of incoming and/or outgoing operations for the personal computing device and the responses thereto. If the personal computing device includes the PCD STS application 46, it will recognize the request to create a control signal received via the PCD screen 42. In recognition of the control channel request signal, the personal computing device responds with an acknowledge signal via the PCD screen 42.

When the vehicle computing system receives the acknowledge signal, it selects one or more sensors to function as the conduit for the control channel. The vehicle computing system then sends a control channel set up signal to the personal computing device via the selected sensor(s). The personal computing device receives the control channel set up signal via at least some of the sensors of the PCD screen 42. The personal computing device evaluates which sensor, or set of sensors, received the control channel set up signal at a desired signal strength level (e.g., the highest signal strength, above a threshold, etc.). The personal computing device selects a sensor, or set of sensors, based on the evaluation to function as its conduit for the control channel.

Periodically, the vehicle computing system and the personal computing device check the signal strength of the control channel. If the signal strength is above a desired threshold (e.g., signal can be detected above noise in the vehicle with negligible error), then the vehicle computing system and the personal computing device keep their respective selection of sensor(s). If the signal strength is below the desired threshold (e.g., experiencing error in interpreting the received signal), then the vehicle computing system and the personal computing device repeat the above process to select different sensors for the control channel.

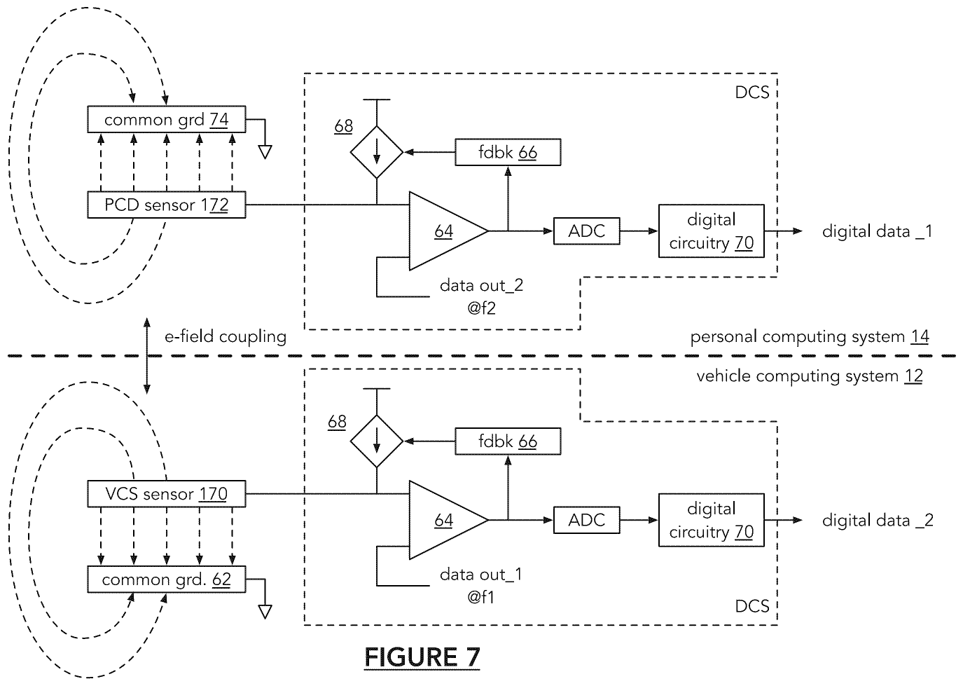

FIG. 7 is a schematic block diagram of an example of e-field signaling as used in screen to screen (STS) data communications. In this diagram, a PCD sensor 172 of the personal computing device (PCD) 14 is e-field coupled to a VCS sensor 170 of the vehicle computing system (VCS) 12. Each sensor 170 and 172 is coupled to a corresponding drive sense circuit (DSC) and a common ground 62 or 74.

The drive sense circuit (DSC) includes an operational amplifier (op-amp) 64, an analog to digital converter (ADC), a feedback circuit 66, a dependent current source 68, and digital circuitry 70. The digital circuitry 70 includes digital bandpass filtering and digital processing.

For a message to be conveyed from the vehicle computing system 12 to the personal computing device 14, the vehicle computing system creates a digital representation of the message. The digital representation of the message is converted into an analog data signal at first frequency (e.g., data out 1 @ f1). For example, the digital representation of the message is modulated onto a sinusoidal signal at the first frequency using amplitude shift keying (ASK), phase shift keying (PSK), a combination of ASK and PSK, or other modulation technique.

The analog data signal (e.g., data out 1 @ f1) is inputting to the op-amp 64. Based on the operation of an op-amp and the feedback loop through the feedback circuit 66 (e.g., unity gain, DC gain, and/or AC gain) and the dependent current source 68, the voltage on the op-amp's other input substantially matches the voltage of the analog data signal. The dependent current source 68 varies the current it sources to the sensor 170 or 172 to maintain the voltage at the op-amp's input.

The analog oscillating current provided to the sensor 170 or 172 creates an electric field between the sensor and a common ground 62 or 74. The e-field radiates in a pattern around the electrode 170 or 172 and, when the other electrode 172 or 170 is in close proximity, receives the e-field. For instance, sensor 170 radiates an e-field regarding the analog data signal (e.g., data out 1 @ f1) and sensor 172 of the personal computing device receives it.

The DSC of the personal computing device 14 processes the received e-field signal to recover the digital data of message (e.g., digital data 1). In particular, as the e-field signal regarding the data sent from the vehicle computing device affects the sensor 172 (e.g., changes an electrical characteristic of the capacitor-based sensor such as impedance, capacitance, voltage, current, etc.), the op-amp and the feedback loop regulate the change out to keep the input voltage of the op-amp inputs substantially matching.

The amount of regulation is reflected in the output of the op-amp. The amount of regulation is converted into a digital signal by the ADC. The digital circuitry 70 band pass filters the digital signal to produce a filtered digital signal. Using sinusoidal signaling, the bandwidth of the bandpass filter can be narrow and centered at the first frequency of the data out 1 @ f1 signal. The digital circuitry 70 processes the filtered digital signal to determine an amount of change of the electrical characteristic caused by the received e-field signal. The amount of change is converted to digital values, which are interpreted to produce a recovered message (e.g., digital data 1).

The personal computing device 14 communication data via STS communications (e.g., e-field signaling) to the vehicle computing system in a similar manner. For full duplex communication, the personal computing device transmits data using a different frequency (e.g., frequency 2) than the frequency (e.g., frequency 1) used by the vehicle computing system. For half duplex commutation, the personal computing device and the vehicle computing system can use the same frequency. Note that the frequency used for STS communications may be in the range of 10 s of Kilohertz to 10s of Gigahertz. For further information regarding STS communications refer to U.S. Pat. No. 11,221,704 entitled “Screen-to-Screen Communications via Touch Sense Elements”.

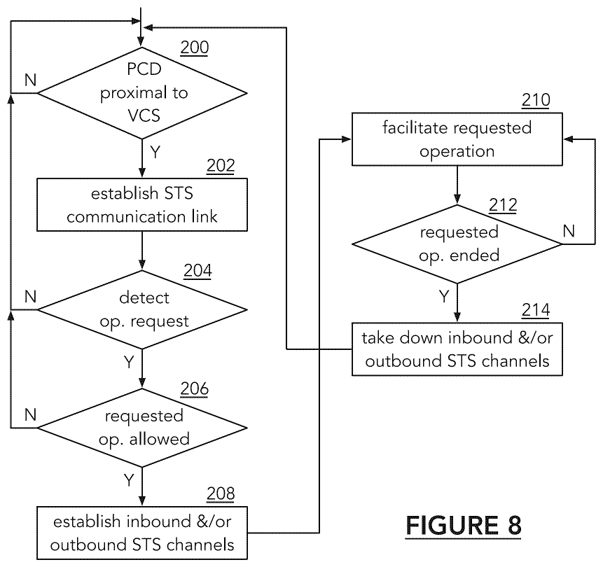

FIG. 8 is a logic diagram of an example of a method for execution by a vehicle computing system to support screen to screen data communications with a personal computing device. The method begins at step 200 where the vehicle computing system (VCS) determines whether a personal computing device (PCD) is in a close proximity to itself. For example, the vehicle computing system a detection message to the personal computing device via more or more sensors of the vehicle screen. If the personal computing device responds with an STS acknowledge signal, the vehicle computing system knows that the personal computing system is physically proximal. If an STS acknowledgement signal is not received in a given time frame, the vehicle computing system determines that the personal computing system is not physically proximal.

When the personal computing device is physically proximal to the vehicle computing system, the method continues at step 202 where the vehicle computing system establishes a screen-to-screen (STS) communication link with a personal computing device. For example, the vehicle computing system establishing a control channel that supports e-field signaling with the personal computing device as discussed with reference to FIG. 7.

The method continues at step 204 where the vehicle computing system detects a requested operation of the personal computing device (e.g., an operation that is primarily executed by the personal computing device such as a phone call, transmitting a text message, receiving a text message, playback of an audio file, playback of video file, etc.). For example, the vehicle computing system receives a notice of an incoming operation via a control channel with the personal computing device. As another example, the vehicle computing system provides a user interface that lists outgoing operations associated with the personal computing device. In furtherance of the example, the vehicle computing system receives an input via the user interface, wherein the input indicates selection of an outgoing operation from the list of outgoing operations. If an operation request is not detected, the method repeats at step 200. Note that if the personal computing device is no longer in close physical proximity, the control channel is taken down and the personal computing device and the vehicle computing system are no longer in STS communication.

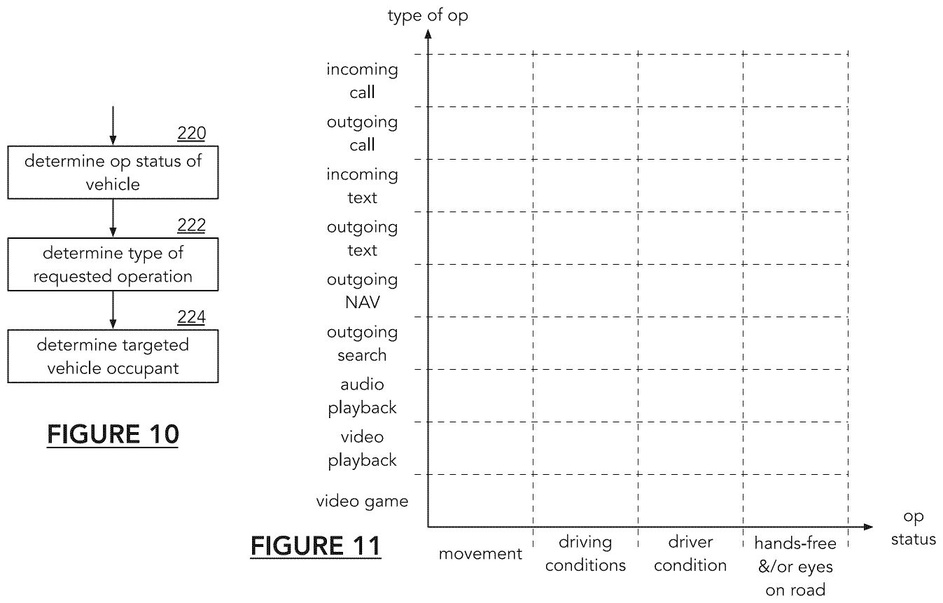

When an operation request is detected, the method continues at step 206 where the vehicle computing system determines whether the requested operation is allowed based on one or more of: operational status of the vehicle, a type of the requested operation, and targeted vehicle occupant. One or more examples of determining allowed operations will be discussed in greater detail with reference to FIGS. 10 and 11. If the request is not allowed, the method repeats at step 200.

If the requested operation is allowed, the method continues to step 208 where the vehicle computing device establishes one or more inbound STS channels for inbound STS signals and/or one or more outbound STS channels for outbound STS signals. Examples of establishing inbound and/or outbound STS channels will be described in greater detail with reference to several subsequent figures.

The method continues at step 210 where the vehicle computing system facilitates the requested operation via the one or more inbound STS channels and/or the one or more outbound STS channels. Examples of facilitating the requested operation will be described in greater detail with reference to several subsequent figures.

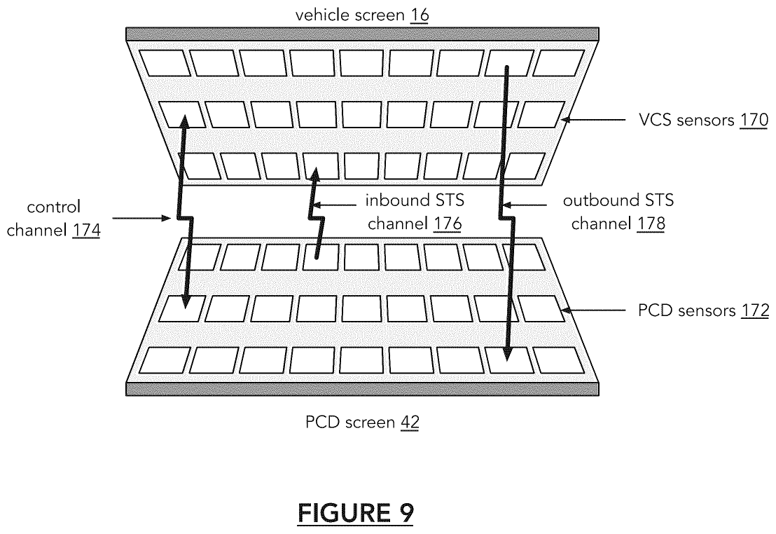

FIG. 9 is a schematic block diagram of another example of screen to screen data communications. This example is similar to the example of FIG. 6 with the addition of an inbound STS channel 176 and an outbound STS channel 178. Note that inbound and outbound are from the perspective of the vehicle computing system.

To set up one or more inbound STS channels 176 and/or one or more outbound STS channels 178, the vehicle computing system communicates with the personal computing system via the control channel 174. For example, for an incoming operation (e.g., call, text, etc.), the vehicle computing system sends a set-up one or more inbound STS channels message to the personal computing device via the control channel 174.

The vehicle computing system determines how many inbound STS channels are needed based on the incoming data rate and the bandwidth capabilities of an outbound STS channel. For example, streaming HD video (1080p) has a data rate of about 3.5 Mbps that can max out at about 5.2 Mbps. As, the vehicle computing system would likely use a data rate of 5.2 Mbps for the incoming data rate. If an STS channel has a bandwidth of 10 Mbps, then one STS channel would suffice.

Having determined that one inbound STS channel is needed, the vehicle computing system sends a message via the control channel to the personal computing device to set up the one inbound STS channel 176. The message would include identify of a frequency to be used for the inbound STS channel. In addition to the sending the message via the control channel, the vehicle computing system would send a test inbound STS channel signal at the designated frequency on one or more sensors of the vehicle screen.

The personal computing device receives the message via the control channel and retrieves the designated frequency. The personal computing device then enables one or more sensors of the PCD screen to detect the presence of the test inbound STS channel signal. If the received signal strength of the test inbound STS channel signal exceeds a threshold, the personal computing device allocates the one or more sensors for the inbound STS channel. If the received signal strength of the test inbound STS channel signal does not exceed the threshold, the personal computing device enables one or more other sensors until it finds a sensor(s) that receive the test inbound STS channel signal at a level above the signal strength threshold.

Once the personal computing device has selected its one or more sensors to support the inbound STS channel, the personal computing device can send incoming data to the vehicle computing device. The inbound STS channel remains active until the current operation is terminated (e.g., a call has ended). When the current operation ends, the personal computing device and the vehicle computing system release their respective sensors assigned to the inbound STS channel 176.

As an example of setting up an outbound STS channel(s), the vehicle computing system determines the that the outgoing data rate is 28 Mbps. With an STS channel bandwidth of 10 Mbps, the vehicle computing system determines that 3 STS channels are needed to support the outbound STS channels for the current operation. The vehicle computing system selects three frequencies and three sensors for the outbound STS channels and assigns each of the three sensors its own one of the three selected frequencies. The message sent via the control channel identifies the three selected frequencies.

The message send via the control channel also indicates how the outgoing data is split. For example, if the outgoing data is a series data words (e.g., 8 bits, 16 bits, 32 bits, 64 bits, etc.), the sensor assigned to first of the three frequencies transmits the first data word per set of three data words; the sensor assigned to second of the three frequencies transmits the second data word per set of three data words; and the sensor assigned to third of the three frequencies transmits the third data word per set of three data words.

The personal computing device selects three sensors to support the outbound STS channel and assigns each sensor a frequency of the three frequencies. This also enables the personal computing device to recover each set of three data words in the proper order. When the current operation ends, the personal computing device and the vehicle computing system release their respective sensors assigned to the outbound STS channel 178.

FIG. 10 is a logic diagram of another example of a method for a vehicle computing system to support screen to screen data communications and in particular a method for determining whether requested operation is allowed. The method begins at step 220 where the vehicle computing system determines operational status of the vehicle regarding movement (e.g., driving, at rest, in park, off, accelerating, decelerating, etc.), driving conditions (e.g., weather conditions, road conditions, visibility, traffic levels, road contours, etc.), and/or driver conditions (e.g., fatigue level, time behind the wheel, stress level, driving pattern, driving habits, etc.).

The method continues at step 222 where the vehicle computing device determines the type of the requested operation (e.g., incoming call, outgoing call, incoming text, outgoing text, outgoing navigation request, outgoing data search request, playback of an audio file, playback of a video file, activate a video game, or other application on the personal computing device).

The method continues at step 224 where the vehicle computing system determines the targeted vehicle occupant as the driver, a front seat passenger, or a rear seat passenger. From the operational status, the type of request, and the targeted vehicle occupant, the vehicle computing system determines when the requested operation should be allowed. The vehicle computing system may further take into account whether, for the driver, the requested operation can be performed substantially hands-free and/or without taking eyes off the road.

FIG. 11 is a schematic block diagram of an example of allowable operations based on type of operation and operational status of the vehicle per occupant of the vehicle. The driver has a different allowable grid than the front seat passenger. A rear seat passenger may have a different grid that the front seat passenger. The grids may be scaled based on age an occupant, which could be inputted into the vehicle computing system or estimated based on size and/or weight of the occupant as sensed via the seat sensors.

The type of movement scales what operations are allowed. The more difficult the driving conditions and/or the more challenging the driver's condition, less operations will be allowed. For passengers, the allowed operations are scaled based on potential annoyance to the driver and further scaled based on driving conditions and/or the driver's condition. As such, the allowability of an operation can be dynamic based on a variety of factors and/or in a variety of combination of factors.

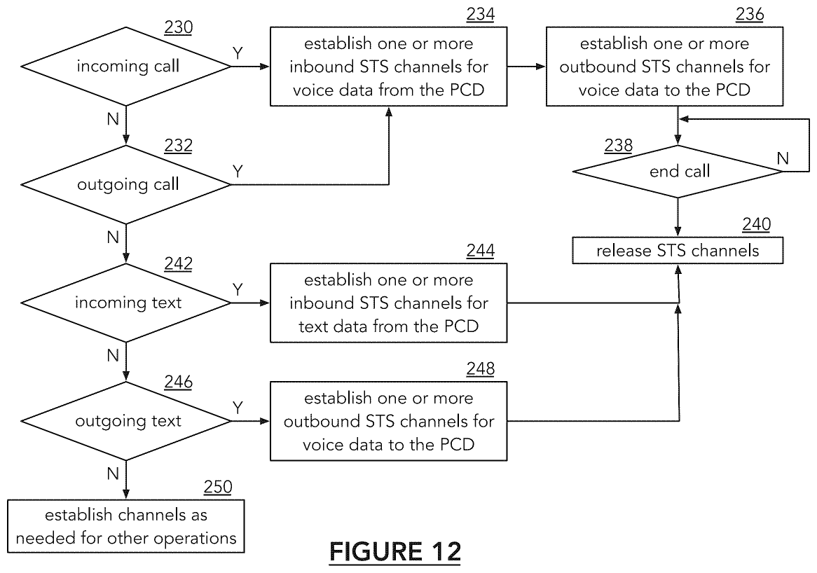

FIG. 12 is a logic diagram of another example of a method for a vehicle computing system to support screen to screen data communications and in particular a method for facilitating requested operation that has been allowed. The method begins at step 230 where the vehicle computing system determines whether the allowed operation is an incoming call. If yes, the method continues at step 234 where the vehicle computing system establishes one or more inbound STS channels for voice data being sent from the personal computing device to the vehicle computing device.

The method continues at step 236 where the vehicle computing system establishes one or more outbound STS channels for voice data being sent to the personal computing device from the vehicle computing device. The method continues at step 238 where the vehicle computing system determines whether the call has ended. Once the call ends, the method continues at step 240 where the vehicle computing system releases the inbound and outbound STS channels.

If, at step 230, the allowed operation is not an incoming call, the method continues at step 232 where the vehicle computing system determines whether the allowed operation is an outgoing call. If yes, the method repeats at step 234.

If, at step 232, the allowed operation is not an outgoing call, the method continues at step 242 where the vehicle computing system where the vehicle computing system determines whether the allowed operation is an incoming text. If yes, the method continues at step 244 where the vehicle computing system establishes one or more inbound STS channels to send a text received by the personal computing device to the vehicle computing system. Note that the text may include text data, video data, image data, graphics data, and/or audio data.

Once the text message has been received by the vehicle computing system, the method continues at step 240 where the vehicle computing system releases the STS channel(s).

If, at step 242, the allowed operation is not an incoming text, the method continues at step 246 where the vehicle computing system determines whether the allowed operation is an outgoing text. If yes, the method continues at step 248 where the vehicle computing system establishes one or more outbound STS channels for sending the outgoing text message from the vehicle computing system to the personal computing device.

If, at step 246, the allowed operation is not an incoming text, the method continues at step 250 where the vehicle computing system establishes inbound and/or outbound STS channels with the personal computing device for another type of operation. When the other type of operation has ended, the vehicle computing system releases the inbound and/or outbound STS channels.

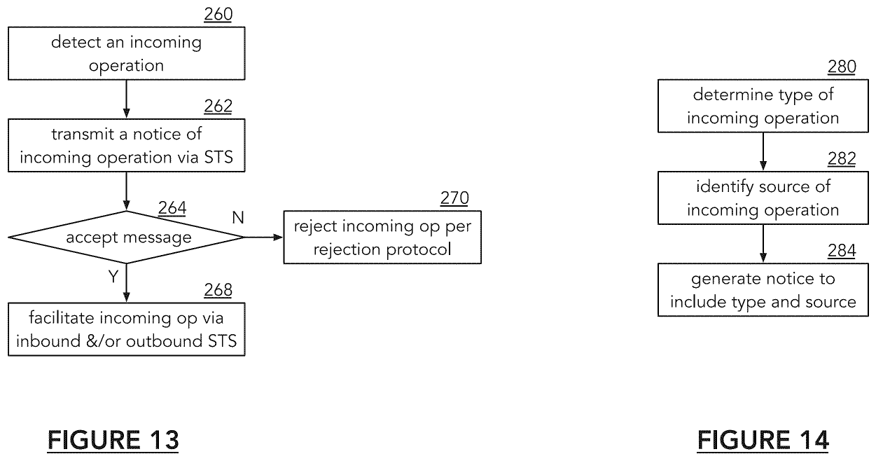

FIG. 13 is a logic diagram of an example of a method for a personal computing device to support screen to screen data communications. The method begins at step 260 where the personal computing device detects an incoming operation (e.g., an incoming call, an incoming text, etc.). The method continues at step 262 where the personal computing device transmits a notice of the incoming operation to a vehicle computing device via a screen-to-screen (STS) communication link (e.g., via the control channel) as previously discussed.

The method continues at step 264 where the personal computing device determines whether it has received an accept message via the STS communication link from the vehicle computing device. If not, the method continues at step 270 where the personal computing device rejects the incoming operation. For example, the personal computing device rejects the incoming operation in accordance with its protocol for rejecting incoming operation requests. For example, for an incoming call, the protocol is to send the call directly to voice mail. As another example for an incoming call, the protocol is to not answer the call and not send it to voicemail.

If, however, the accept message is received at step 264, the method continues at step 268 where the personal computing device facilitates the incoming operation via one or more of: one or more inbound STS channels for inbound STS signals and one or more outbound STS channels for outbound STS signals. For example, for an incoming call, the personal computing device establishes, with the vehicle computing system, an inbound STS channel for voice signals received by the personal computing device and sent to the vehicle computing system and an outbound STS channel for voice signals received by the vehicle computing system and sent to the personal computing system for transmission via the communication module.

FIG. 14 is a logic diagram of another example of a method for a personal computing device to support screen to screen data communications and, in particular, the transmitting the notice of the incoming operation. The method begins at step 280 where the personal computing device determines a type of the incoming operation. The type of incoming operation includes, but is not limited to, an incoming call, an incoming text, an incoming notification, and an incoming data transfer request, etc.

The method continues at step 282 where the personal computing device determines identity of a source of the incoming operation. For example, the phone number and/or name associated with incoming call, an incoming text, etc. The method continues at step 284 where the personal computing device generates the notice of the incoming operation to include the type of the incoming operation and the identity of the sources of the incoming operation.

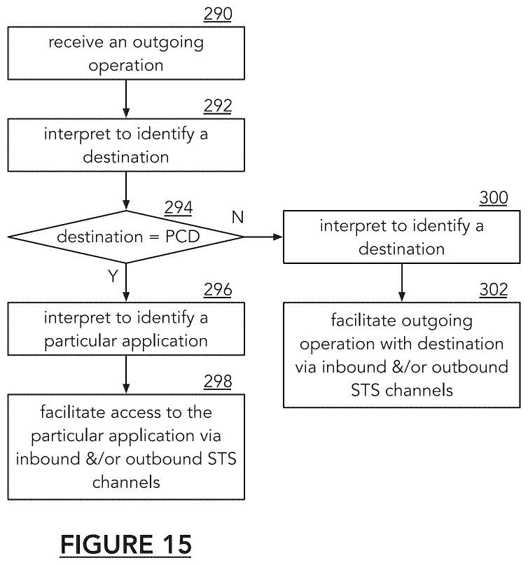

FIG. 15 is a logic diagram of another example of a method for a personal computing device to support screen to screen data communications and, in particular, supporting an outgoing operation. The method begins at step 290 where the personal computing device receives an outgoing operation from a vehicle computing device via a screen-to-screen (STS) communication link (e.g., the control channel). The outgoing operation includes information regarding a requested operation, which includes, but is not limited, an outgoing text message, an outgoing call, an audio playback request of stored audio file, a video playback request of a stored video file (which may further include image data and/or graphics data), an audio playback request of streaming audio, a video playback request of streaming video, an internet search, and/or a navigation function.

The method continues at step 292 where the personal computing device interprets the information regarding the outgoing operation to identify a destination of the outgoing operation. If the destination is the personal computing device (PCD) for audio playback, video playback, and the like, the method continues at step 296 where the personal computing device further interprets the information regarding the outgoing operation to identify a particular application (e.g., playback of stored audio file, playback of a stored video file, a stream audio application, a streaming video application, a web browser for an internet search, a navigation application, etc.).

The method continues at step 298 where the personal computing device facilitates access to the particular application by the vehicle computing system via one or more of: one or more inbound STS channels and one or more outbound STS channels. For example, for playback of an audio file, the personal computing device generates audio signals via a playback application and sends the audio signals to the vehicle computing system via the inbound STS channel(s). The vehicle computing system provides audio playback control messages (e.g., pause, skip, etc.) to the personal computing device via the outbound STS channel(s) and/or via the control channel.

If, at step 294, the personal computing device is not the destination, the method continues at step 300 where the personal computing device interprets the information regarding the outgoing operation to identify a destination (e.g., targeted destination of a text, a call, a third party website for an internet search, etc.). The method continues at step 302 where the personal computing device facilitates the outgoing operation between the identified destination and the vehicle computing system via the one or more of: the one or more inbound STS channels and the one or more outbound STS channels.

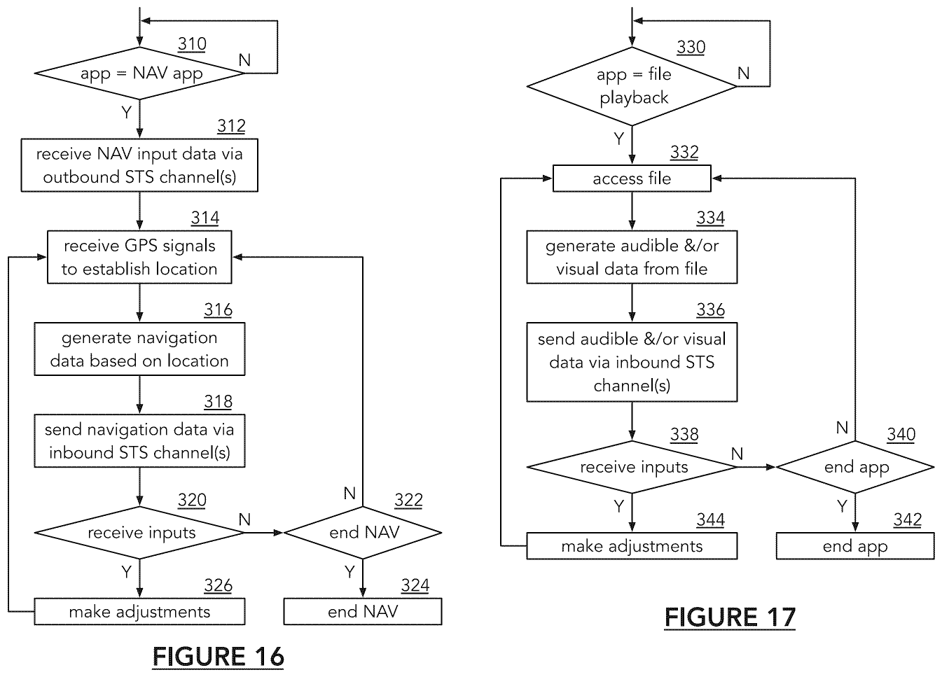

FIG. 16 is a logic diagram of another example of a method for a personal computing device to support screen to screen data communications and, in particular, facilitating access to a navigation application. The method begins at step 310 where the personal computing device determines whether access to the navigation application is being requested. When it is, the method continues at step 312 where the personal computing device receives navigation (NAV) input data via the outbound STS channel(s). The NAV input data includes one or more of, but not limited to, a destination address, a request for a list of nearby services, change view, zoom in, zoom out, increase volume, change destination, etc.

The method continues at step 314 where the personal computing device receives Global Positioning Satellite (GPS) signals to establish a location of the vehicle. The method continues to step 316 where the personal computing device generates navigation data by mapping the location of the vehicle to an image (e.g., graphical and/or images) of a geographic area in accordance with the navigation input data. The method continues at step 318 where the personal computing device sends the navigation data to the vehicle computing system via the one or more inbound STS channels.

The method continues at step 320 where the personal computer device determines whether it has received additional NAV input data. If not, the method continues at step 322 where the personal computing device determines whether to end the navigation (e.g., based on an end NAV message. If not, the method repeats at step 314. If the NAV is to end, the method continues at step 324 where the personal computing device ends the navigation (e.g., turn off the NAV application, end the current NAV function, etc.).

If, at step 320, additional NAV data inputs are received, the method continues to step 326 where the personal computing device adjusts the navigation operation based on the additional NAV data inputs (e.g., new destination, list of services, change view, etc.). The method then repeats at step 314.

FIG. 17 is a logic diagram of another example of a method for a personal computing device to support screen to screen data communications and, in particular, facilitating access to a playback file application. The method begins at step 330 where the personal computing device determines whether access to a playback application is being requested. The application plays back one or more of an audio file, a video file, an image file, and/or a graphics file.

When it is, the method continues at step 332 where the personal computing device accesses a particular file. The method continues at step 334 where the personal computing device generates audible data and/or visual data (e.g., video data, graphics data, text data, and/or image data) from the file. The method continues at step 334 where the personal computing devices sends the audible data and/or the visual data to the vehicle computing system via the one or more inbound STS channels.

The method continues at step 338 where the personal computing device determines whether it receives inputs regarding execution of the playback application (e.g., pause, stop, rewind, fast-forward, skip, etc.). If so, the method continues at step 334 where the personal computing device makes adjustments to the playback of the file based on the inputs. Having made the adjustments, the method repeats at step 332.

If no new inputs are received at step 338, the method continues at step 340 where the personal computing device determines whether to end the execution of the playback application (e.g., received an end message, etc.). If not, the method repeats at step 332. If yes, the method continues at step 342 where the personal computing devices ends execution of the playback application.

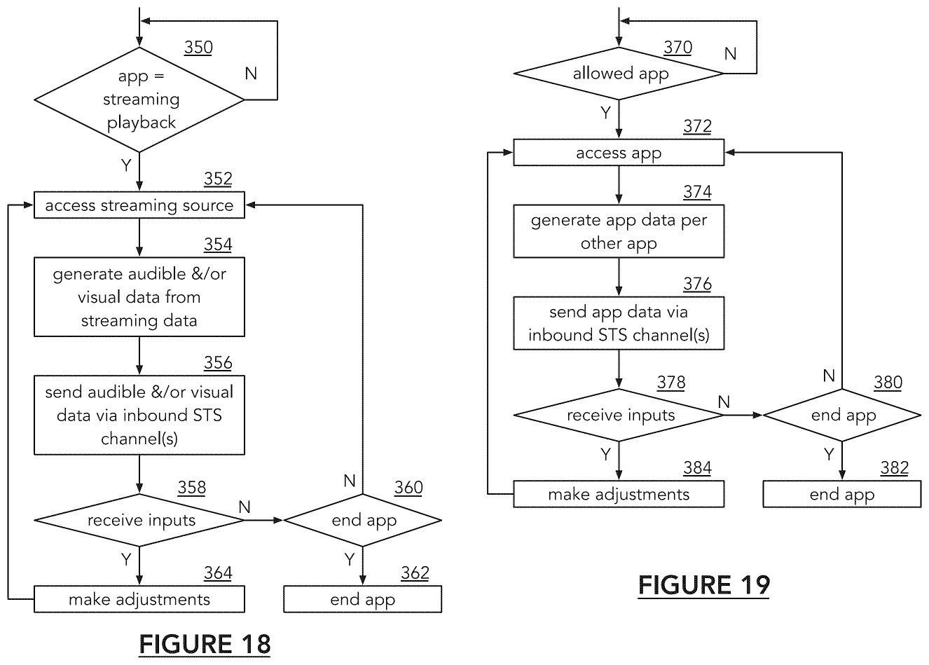

FIG. 18 is a logic diagram of another example of a method for a personal computing device to support screen to screen data communications and, in particular, facilitating access to a stream playback of audio and visual data. The method begins at step 350 where the personal computing device determines whether access to a streaming playback application is being requested. A streaming playback application accesses an on-line source to play back one or more of an audio file, a video file, an image file, and/or a graphics file.

When access to the streaming playback application is requested, the method continues at step 352 where the personal computing device accesses (e.g., enables execution of) the streaming playback application (e.g., Sonos, Pandora, Netflix, (all trademarked), etc.). The method continues at step 354 where the personal computing device receives streaming data from the playback source and generates audible data and/or visual data therefrom. The method continues at step 356 where the personal computing devices sends the audible data and/or the visual data to the vehicle computing system via the one or more inbound STS channels.

The method continues at step 358 where the personal computing device determines whether it has received streaming playback inputs from the vehicle computing device. If not, the method continues at step 360 where the personal computing device determines whether to end the execution of the streaming playback application. If not, the method repeats at step 352. If yes, the method continues at step 362 where the personal computing device ends execution of the streaming playback application.

If, at step 358, the personal computing device received an input (e.g., pause, stop, rewind, fast-forward, skip, etc.), the method continues at step 364 where the personal computing device makes an adjustment to the playback of the audible and/or visual data based on the input(s). Having made the adjustment, the method repeats at step 352.

FIG. 19 is a logic diagram of another example of a method for a personal computing device to support screen to screen data communications and, in particular, facilitating access to an application that is on the vehicle computing system's list of allowed applications (e.g., image capture, on-line store application, security camera, etc.). The method begins at step 370 where the personal computing device determines whether access to the allowed application has been requested.

When access to the allowed application is requested, the method continues at step 372 where the personal computing device accesses (e.g., enables execution of) the allowed application. The method continues at step 374 where the personal computing device generates data in accordance with the allowed application (e.g., a user interface for an on-line store). The method continues at step 376 where the personal computing devices sends the data to the vehicle computing system via the one or more inbound STS channels.

The method continues at step 378 where the personal computing device determines whether it has received an input from the vehicle computing device regarding execution of the allowed application. If not, the method continues at step 380 where the personal computing device determines whether to end the execution of the allowed application. If not, the method repeats at step 372. If yes, the method continues at step 382 where the personal computing device ends execution of the allowed application.

If, at step 378, the personal computing device received an input, the method continues at step 384 where the personal computing device makes an adjustment to the execution of the allowed application and/or generation of the visual data based on the input(s). Having made the adjustment, the method repeats at step 372.

The methods of FIGS. 16-19 have been discussed with reference to a single application. The personal computing device is able to execute multiple applications at a given time. For example, the personal computing device executes the playback of an audio file while also executing a navigation application. For concurrent application processing, each application may have its own inbound STS channel and outbound STS channel (if needed), the active applications share inbound STS channel(s) and outbound STS channel(s) (if needed), and/or a combination thereof.

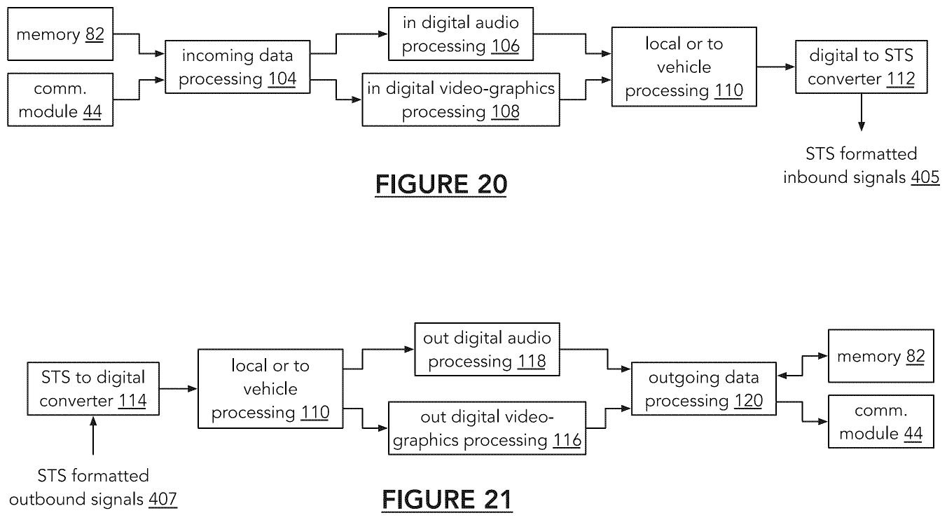

FIG. 20 is a schematic block diagram of an example of incoming data processing to produce screen-to-screen (STS) formatted inbound signals within the personal computing device. The inbound STS path includes memory 82, the communication module 44, the incoming data processing module 104, the inbound digital audio processing module 106, the inbound digital video-graphics processing module 108, the local or to vehicle processing module 110, and the digital to STS converter 112.

In addition to previous discussion and/or in addition to subsequent discussion, incoming data is retrieved from the memory 82 and/or received from the communication module 44. For example, an incoming text or incoming call is received by the communication module 44. As another example, a stored file (e.g., audio, video, graphics, text, image, etc.) is retrieved from memory 82. As a further example, for streaming data (e.g., audio, video, graphics, text, image, etc.), an application is retrieved from memory 82, executed by the processing module 80, which utilizes the communication unit 44 to receive streaming data from a streaming data source.

The incoming data processing module 104 routes, splits, and/or combines the incoming data and provides it to the inbound digital audio processing module 106 and/or to the inbound digital video-graphics processing module 108. For example, inbound voice data received by the communication module 44 is routed to the inbound digital audio processing module 106. As another example, an inbound text received by the communication module is routed to the inbound digital video-graphics processing module 108.

As another example, when an audio file playback application is active and a navigation application is active, the incoming data processing module 104 combines the audio data produced by the navigation application with the audio data produced by the audio playback application and provides the combined audio to the inbound digital audio processing module 106. The incoming data processing module 104 also combines the video-graphics data produced by the navigation application with the video-graphics data produced by the audio playback application and provides the combined video-graphics data to the inbound digital video-graphics processing module 108.

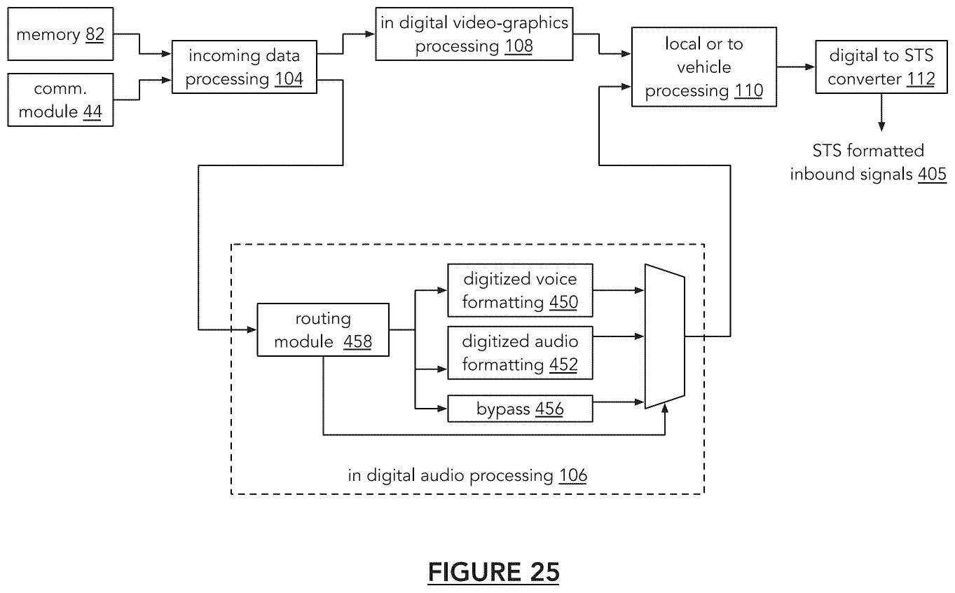

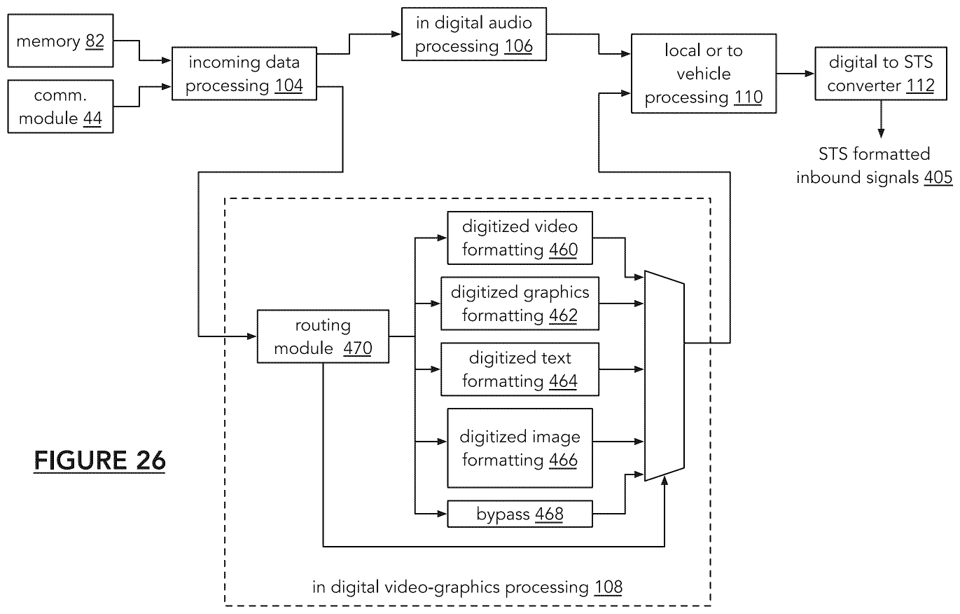

The inbound digital audio processing module 106 functions to convert the digital format of the received audio data, if needed. The functionality of the inbound digital audio processing module 106 will be described in greater detail with reference to FIG. 25. The inbound digital video-graphics processing module 108 functions to convert the digital format of the received video-graphics data, if needed. The functionality of the inbound digital video-graphics processing module 108 will be described in greater detail with reference to FIG. 26.

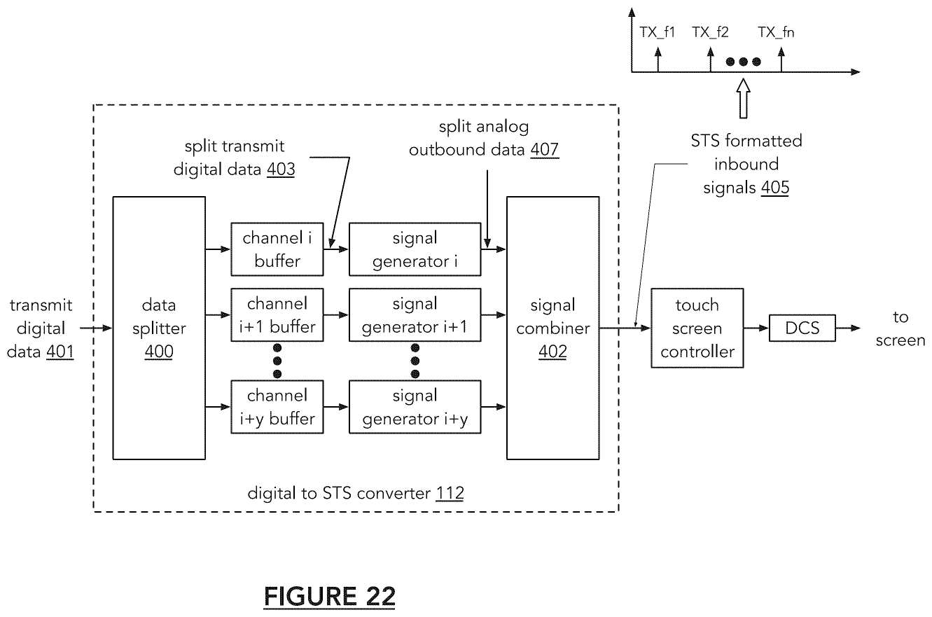

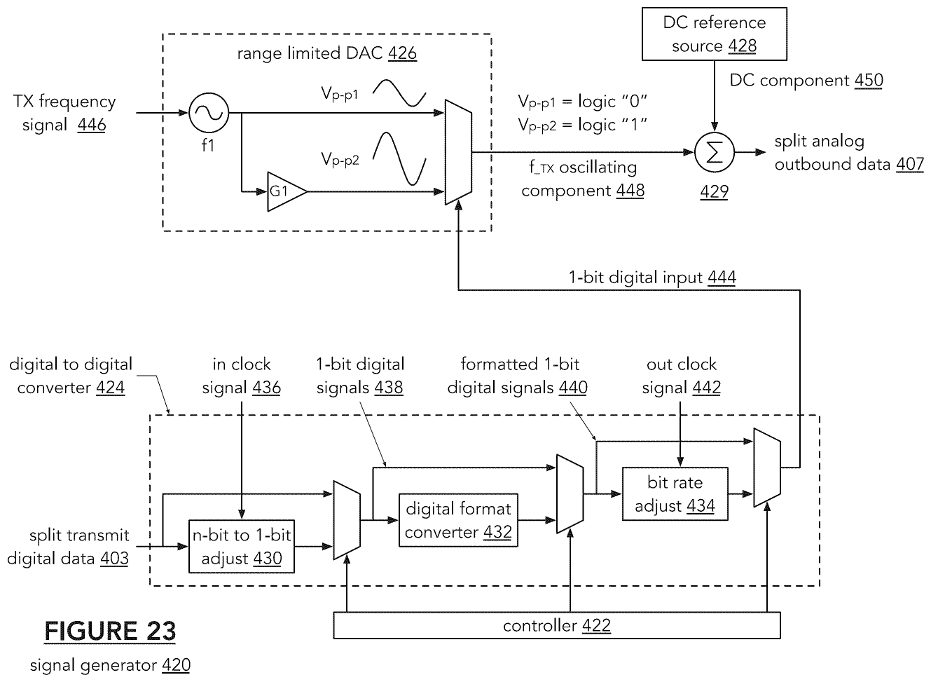

The local or to vehicle processing module 110 functions to routed inbound audio data and/or inbound video-graphics data to the speaker(s) and/or display(s) of the personal computing device or to the vehicle computing system via the digital to STS converter 112. The digital to STS converter 112 will be described in greater detail with reference to FIGS. 22 and 23.

FIG. 21 is a schematic block diagram of an example of outgoing data processing from screen-to-screen (STS) formatted outbound signals within the personal computing device. STS formatted outbound signals 407 are received by the STS to digital converter 114 via the outbound STS channel(s). The STS to digital converter 114 recovers outbound audio data and/or outbound video-graphics data from the STS formatted outbound signals 407. The local or to vehicle processing module 110 receives the recovered audio data and/or outbound video-graphics data and routes it to the outbound digital audio processing module 118 and/or to the outbound digital video-graphics processing module 116.

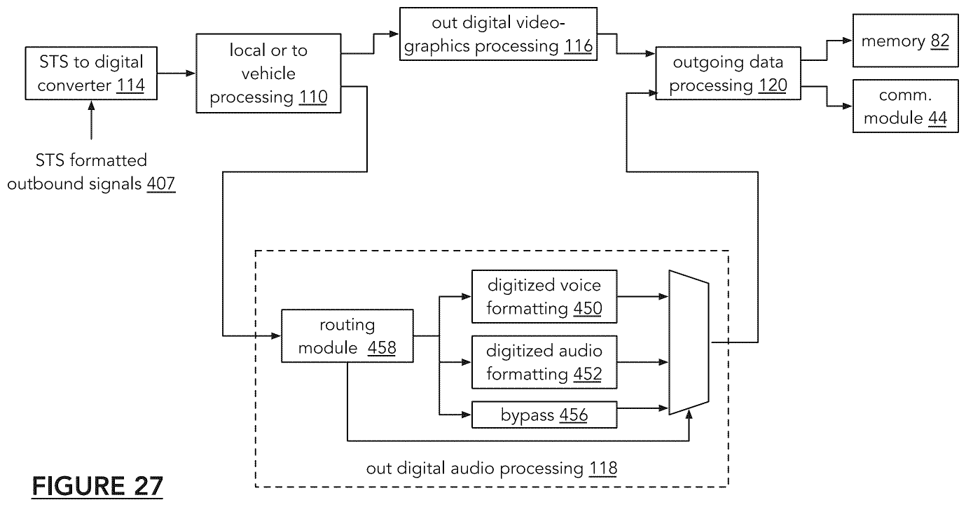

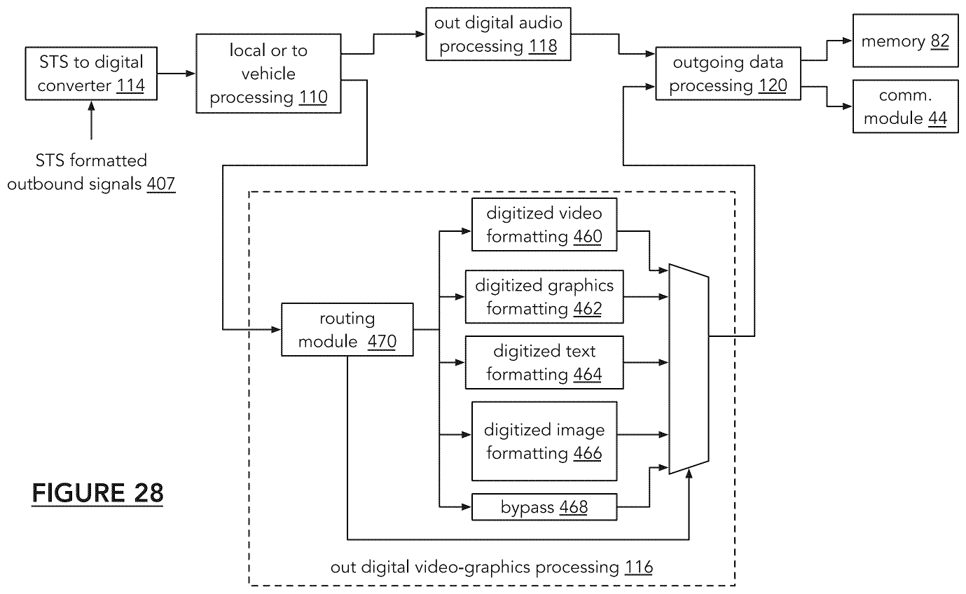

The outbound digital audio processing module 118 functions to convert the digital format of the recovered audio data, if needed. The functionality of the outbound digital audio processing module 106 will be described in greater detail with reference to FIG. 27. The outbound digital video-graphics processing module 116 functions to convert the digital format of the recovered video-graphics data, if needed. The functionality of the outbound digital video-graphics processing module 116 will be described in greater detail with reference to FIG. 28.

The outgoing data processing module 120 functions to route, combine, and/or split the digital audio data it receives from the outbound digital audio processing module 118 and/or the digital video-graphics data it receives from the outbound digital video-graphics processing module 116. For example, the outgoing data processing module 120 routes the received digital audio data to the communication module 44 for transmission to a destination. As another example, the outgoing data processing module 120 routes the received digital video-graphics data to the communication module 44 for transmission to a destination.

As another example, the outgoing data processing module 120 combines the received digital audio data with retrieved audio data and/or video data from the memory 82 (e.g., stored information regarding the personal computing device, etc.). The outgoing data processing module 120 provides the combined data to the communication module 22 for transmission to a destination.

FIG. 22 is a schematic block diagram of an embodiment of a digital to screen-to-screen (STS) converter 112 supports conversion of digital data into STS formatted inbound signals 405 that are transmitted from a screen (e.g., screen 16 of the vehicle computing system or screen 42 of the personal computing device) to another screen. The STS formatted inbound signals 405 are transmitted via one or more STS channels, where an STS channel is supported by the touch screen controller and a drive sense circuit (DSC). For instance, two DSCs supports two STS channels.

Each drive sense circuit (DSC) supports one or more frequencies, where the data is represented in the frequency domain. The data rate of a frequency is dependent on the frequency and the data modulation scheme. For example, a 1 MHz sinusoidal signal using ASK on a cycle by cycle basis has a data rate of 1 Mbps (mega-bit per second). As another example, a 1 MHz sinusoidal signal using ASK and PSK on a cycle by cycle basis has a data rate of 2 Mbps. As a further example, a 2 MHz sinusoidal signal using ASK on a cycle by cycle basis has a data rate of 2 Mbps. To balance the data rate of different frequencies, the 1 MHz sinusoidal signal using ASK on a cycle by cycle basis has a data rate of 1 Mbps and the 2 MHz sinusoidal signal using ASK on a two-cycle by two-cycle basis has a data rate of 1 Mbps.

For an STS channel, the digital to STS converter 112 includes a data splitter 400, a plurality of channel buffers, a plurality of signal generators, and a signal combiner 402. The signal combiner 402 is coupled to a drive sense circuit (DSC). The data splitter 400 receives the transmit digital data 401 from the processing module 130 of the personal computing device or from the processing module 80 of the vehicle computing system. The data splitter 400 divides the data 401 into a plurality of data streams. The number of data streams is based on the data rate of transmit digital data 401, and the data rate of each frequency of an STS channel.

For example, if the data rate of the transmit digital data 401 (e.g., audio data, video data, image data, graphics data, text data, a combination thereof, etc.) is 2 Mbps and the data rate of frequency #1 and frequency #2 are each 1 Mbps, then the data splitter 400 divides the transmit digital data 401 into two data streams of 1 Mbps each (e.g., split transmit digital data 403). The first data stream is provided to a first buffer and the second data stream is provided to a second buffer.

The first signal generator receives the first data stream from the first buffer to create first frequency modulated data (e.g., part of the split analog outbound data 407). The second signal generator receives the second data stream from the second buffer to create second frequency modulated data (e.g., a second part of the split analog outbound data 407). The signal generator will be described in greater detail with reference to FIG. 23.

The signal combiner 402 (e.g., a wire, an adder, a multiplexer, an aggregator, etc.) combines the outputs of the signal generators to produce STS formatted inbound signals 405. Each output of a signal generator is represented in the frequency domain. For example, the output of the first signal generator is represented as TX_f1 (e.g., frequency 1); the output of the second signal generator is represented as TX_f2 (e.g., frequency 2); and so on.

The touch screen controller receives the STS formatted inbound signals 405 and provides them to the drive sense circuit (DSC), which drives the STS formatted inbound signal 405 on to a screen (e.g., 16 or 42) for e-field signaling transmission. Note that, in an alternate embodiment, some to all of the digital to STS converter 112 is implemented within the touch screen controller.

As another example, if the data rate of the transmit digital data 401 (e.g., audio data, video data, image data, graphics data, text data, a combination thereof, etc.) is 1 Mbps and the data rate of frequency #1 and frequency #2 are each 1 Mbps, then only one frequency is needed. In this example, the data splitter 400 and the data combiner 402 are bypassed or they perform their specific functions for a single stream of data.

FIG. 23 is a schematic block diagram of an embodiment of a signal generator 420 of a digital to screen-to-screen (STS) converter 112. The signal generator 420 includes a controller 422, a digital to digital converter 424, a range limited DAC 426, a DC reference source 428, and a summation module 429. The range limited DAC 426 includes a sinusoidal signal source, a gain module, and a multiplexer.

The digital to digital converter 424 has three stages: a serialize and/or input bit rate adjust stage; a digital format stage; and an output bit rate adjust stage. The first stage includes an n-bit to 1-bit adjust module 430 and a first multiplexer; the second stage includes a digital format converter 432 and a second multiplexer; and the third stage includes a bit rate adjust module 434 and a third multiplexer.

The first stage (e.g., serialize and/or input bit rate adjust) receives a split transmit digital data 403 (e.g., an outbound of a channel buffer that corresponds to the stream of data from the data splitter 400 or one of the streams of data from the data splitter 400). The controller 422 determines whether the received data stream is already serialized and is at the appropriate bit rate. For example, the controller 442 receives information from processing module 88 or 130 regarding how the inbound digital audio processing module 106 and/or how the inbound digital video-graphics processing module 108 generated the transmit digital data 401 and how it was split.

If controller 422 determines that the split transmit digital data 403 (i.e., the received data stream) is already a single bit stream and is at the desired data rate, it bypasses the n-bit to 1-bit adjust module 430 and sends the received data stream to the second stage via the first multiplexer as a data stream of 1-bit digital input signals 438.

If, however, the split transmit digital data 403 (i.e., the received data stream) is not a single bit stream and/or is not at the desired data rate, the controller 422 enables the n-bit to 1-bit adjust module 430 to makes one or more appropriate adjustments. For example, if the data rate is not in accordance with inbound clock signal 436, the n-bit to 1-bit adjust module 430 adjusts the serial bit rate of split transmit digital data 403 to be in accordance with the inbound clock signal. As another example, if the split transmit digital data 403 is received in data words (e.g., 8 bits, 16 bits, etc.), the n-bit to 1-bit adjust module 430 serializes the data words to produce the single bit data stream. The resulting adjusted data stream is sent to the second stage as a data stream of 1-bit digital input signals 438.

In the second stage of the digital to digital converter 424, the controller determines whether the data stream of 1-bit digital input signals 438 is in the desired digital data format for binary values. A binary value can be expressed in a variety of forms. In a first example format, a logic “1” is expressed as a positive rail voltage for the duration of a 1-bit clock interval and logic “0” is expressed as a negative rail voltage for the duration of the 1-bit clock interval; or vice versa. The positive rail voltage refers to a positive supply voltage (e.g., Vdd) that is provided to a digital circuit (e.g., a circuit that processes and/or communicates digital data as binary values), the negative rail voltage refers to a negative supply voltage or ground (e.g., Vss) that is provided to the digital circuit, and the common mode voltage (e.g., Vcm) is halfway between Vdd and Vss. The 1-bit clock interval corresponds to the inverse of a 1-bit data rate. For example, if the 1-bit data rate is 1 Gigabit per second (Gbps), then the 1-bit clock interval is 1 nano-second).

In a second example format, a logic “1” is expressed as a non-return to zero waveform that, for the first half of the 1-bit interval, is at the positive rail voltage (Vdd) and for the second half of the 1-bit interval is at the negative rail voltage (Vss). A logic “0” is expressed as a non-return to zero waveform that, for the first half of the 1-bit interval, is at the negative rail voltage (Vss) and for the second half of the 1-bit interval is at the positive rail voltage (Vdd). Alternatively, a logic “0” is expressed as a non-return to zero waveform that, for the first half of the 1-bit interval, is at the positive rail voltage (Vdd) and for the second half of the 1-bit interval is at the negative rail voltage (Vss). A logic “1” is expressed as a non-return to zero waveform that, for the first half of the 1-bit interval, is at the negative rail voltage (Vss) and for the second half of the 1-bit interval is at the positive rail voltage (Vdd).

In a third example format, a logic “1” is expressed as a return to zero waveform that, for the first half of the 1-bit interval, is at the positive rail voltage (Vdd) and for the second half of the 1-bit interval is at the common mode voltage (Vcm). A logic “0” is expressed as a return to zero waveform that, for the first half of the 1-bit interval, is at the negative rail voltage (Vss) and for the second half of the 1-bit interval is at the common mode voltage (Vcm). Alternatively, a logic “0” is expressed as a return to zero waveform that, for the first half of the 1-bit interval, is at the positive rail voltage (Vdd) and for the second half of the 1-bit interval is at the common mode voltage (Vcm). A logic “1” is expressed as a return to zero waveform that, for the first half of the 1-bit interval, is at the negative rail voltage (Vss) and for the second half of the 1-bit interval is at the common mode voltage (Vcm).

With any of the digital data formats, a logic value needs to be within 10% of a respective rail voltage to be considered in a steady data binary condition. For example, for format 1, a logic 1 is not assured until the voltage is at least 90% of the positive rail voltage (Vdd). As another example, for format 1, a logic 0 is not assured until the voltage is at most 10% of the negative rail voltage (Vss).

If the controller 422 determines that the data stream of 1-bit digital input signals 438 is in the desired digital data format, the controller 422 passes the data stream of 1-bit digital input signals 438, as a data stream of formatted 1-bit digital signals 440, to the third stage via the second multiplexer.

If, however, the controller 422 determines that the data stream of 1-bit digital input signals 438 is not in the desired digital data format, the controller enables the digital format converter 432 to change the format of the data stream of 1-bit digital input signals 438 into the desired digital data format. The resulting data stream of formatted 1-bit digital signals 440 is provided to the third stage via the second multiplexer.

In the third stage of the digital to digital converter 424, the controller determines whether the data stream of formatted 1-bit digital signals 440 is at the desired output data rate. For example, the desired output data rate corresponds to the frequency of the sinusoidal signal source of the range limited DAC 426 and the number of cycles per encoding. As a specific example, the frequency of the sinusoidal signal produced by the sinusoidal signal source is 1 MHz and the encoding (e.g., ASK) is done per cycle, then the desired outbound data rate is 1 Mbps (e.g., 1 bit per one cycle of the 1 MHz sinusoidal signal). In this specific example, the output clock signal 442 is set to be 1 MHz.

As another specific example, the frequency of the sinusoidal signal produced by the sinusoidal signal source is 1 MHz and the encoding (e.g., ASK) is done every two cycles, then the desired outbound data rate is 500 Kbps (e.g., 1 bit per every two cycles of the 1 MHz sinusoidal signal). In this specific example, the output clock signal 442 is set to be 1 MHz.

If the data stream of formatted 1-bit digital signals 440 is at the desired output data rate, the controller 422 enables a bit of data to be outputted at the desired output data rate to produce a 1-bit digital input signal 444 (e.g., input with respect to the range limited DAC 426). If, however, the data stream of formatted 1-bit digital signals 440 is not at the desired output data rate, the controller 422 enables the bit rate adjust module 434 to adjust the data rate of data stream of formatted 1-bit digital signals 440 to be at the desired output data rate.

The range limited DAC 426 converts, on a bit by bit basis, the 1-bit digital input 444 into a voltage or current limited analog signal. In this example, the sinusoidal signal source generates a sinusoidal signal having a particular frequency (e.g., f_TX). The voltage or current magnitude of the sinusoidal signal is limited to a fraction of the rail to rail voltage and/or to a fraction of the source current. As a specific example rail to rail voltage is 1.5 volts and the sinusoidal signal source generates a sinusoidal signal having a peak-to-peak voltage of 10 milli-voltages to 100 milli-voltages or more (but less than 90% of the rail to rail voltage).

The gain module (G1) of the range limited DAC 426, doubles (or some other multiplier) the magnitude sinusoidal signal (Vₚ₋ₚ₁) to produce a sinusoidal signal having a second peak-to-peak voltage (Vₚ₋ₚ₂). The 1-bit digital input 444 is the input control of the multiplexer of the range limited DAC 426. When a bit of the 1-bit digital input 444 is a logic “1”, the multiplexer outputs the sinusoidal signal having a second peak-to-peak voltage (Vₚ₋ₚ₂) and when a bit of the 1-bit digital input 444 is a logic “0”, the multiplexer outputs the sinusoidal signal having a first peak-to-peak voltage (Vₚ₋ₚ₁).

The summing module 429 sums the f_TX oscillating component 448 (e.g., the output of the range limited DAC 426) with a DC component 450 to produce the split analog outbound data 407. The DC reference source 428 generates a DC voltage reference (e.g., halfway between the rail-to-rail voltage) as the DC component 450.

As an alternative to ASK data encoding, the range limited DAC 426 uses phase shift keying (PSK). In this embodiment, the gain module (G1) is replaced with a 180 degree phase shift module. Thus, a logic “0” is represented by a 0 degree phase shifted sinusoidal signal an a logic “1” is represented by a 180 degree phase shifted sinusoidal signal.

In yet another embodiment, the range limited DAC 426 uses both ASK and PSK to encode data. In this embodiment, the digital input signal 444 would be a 2-bit signal. One bit to indicate ASK encoding and the second bit for PSK encoding.

For further information regarding the operation of a signal generator, refer to issued U.S. Pat. No. 10,831,690 entitled “Channel Allocation Among Low Voltage Drive Circuits” and/or to issued U.S. Pat. No. 11,221,980 entitled “Low Voltage Drive Circuit Operable to Convey Data via a Bus”.

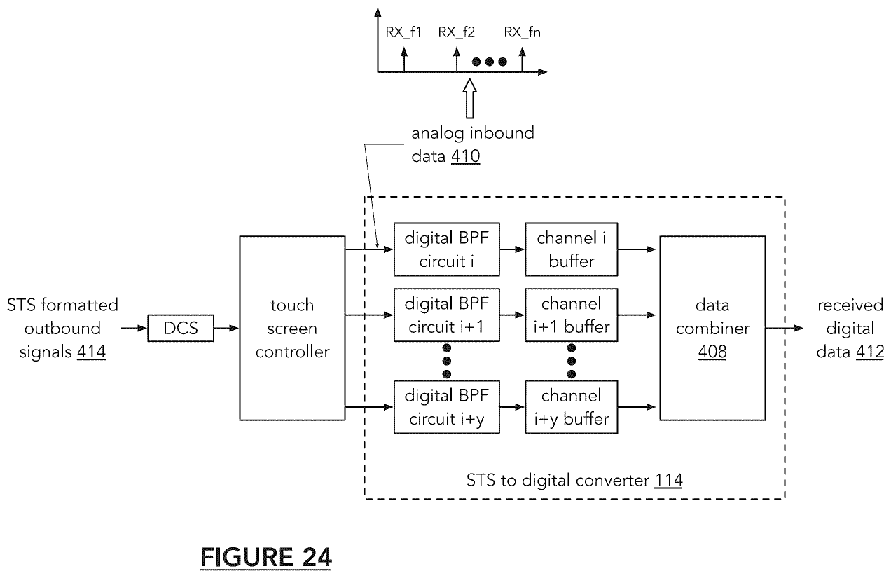

FIG. 24 is a schematic block diagram of an embodiment of a screen-to-screen (STS) to digital converter 114 that includes a plurality of digital bandpass filters (BPF), a plurality of channel buffers, and a data combiner 408. The STS to digital converter 114 receives analog inbound data 410 from the touch screen controller and a drive sense circuit (DSC).

The DSC receives STS formatted outbound signals 414 from a corresponding screen and produces, therefrom, sensed signals represented the data embedded in the STS formatted outbound signals 414. The touch screen controller generates, from the sensed signals, the analog inbound data 410, which includes one or more signal components at a specific receive frequency (RX). For instance, the analog inbound data 410 corresponds to the STS formatted inbound signals 405 generated by the digital to STS converter 112. As an example, a particular frequency component of the analog inbound data 410 corresponds to one of the split analog outbound data 407 produced by a signal generator. As such, a component (e.g., RX_f1) of the analog inbound data 410 corresponds to one of the split analogy outbound data 407 (e.g., f_TX oscillating component 448).

A first frequency component signal of the analog inbound data (e.g., RX_f1) is provided to a first digital BPF circuit; a second frequency component signal of the analog inbound data (e.g., RX_f2) is provided to a second digital BPF circuit; and so on. Each digital bandpass filter filters its corresponding frequency component signal to recover the embedded data in the signal. The embedded data is stored in a corresponding buffer and is combined via the data combiner 408 to recover the received digital data 412, which is subsequently processed by the processing module 80 of the vehicle computing system or by the processing module 130 of the personal computing device.

For further information regarding the operation of filtering by the STS to digital converter, refer to issued U.S. Pat. No. 10,831,690 entitled “Channel Allocation Among Low Voltage Drive Circuits”, issued U.S. Pat. No. 11,221,980 entitled “Low Voltage Drive Circuit Operable to Convey Data via a Bus”, and/or issued U.S. Pat. No. 11,003,205 entitled “Receive Analog to Digital Circuit of a Low Voltage Drive Circuit Data Communication System”.

FIG. 25 is a schematic block diagram of an example of incoming audio data processing to produce screen-to-screen (STS) formatted inbound signals. This diagram is similar to the diagram of FIG. 20 with the inclusion of further detail of the inbound digital audio processing module 106. The inbound digital audio processing module 106 includes a routing module 458, a digital voice formatting module 450, a digitized audio formatting module 452, a bypass 456, and an output multiplexer.

The routing module 458 receives inbound voice data and/or inbound audio data and determines whether it should be format processed. For example, the routing module 458 receives a processing instruction regarding the inbound voice data and/or inbound audio data; the processing instruction indicates the type of format processing, if any, and whether multiple format processing steps are needed. As another example, the routing module 458 interprets inbound voice data and/or inbound audio data to determine the type of format processing, if any, and whether multiple format processing steps are needed.

The desired format for voice data and/or for audio data is selectable by the personal computing device and/or by the vehicle computing system. If the received voice data and/or audio data is in the desired format, the routing module 458 sends the voice data and/or audio data via the bypass 456 and the multiplexer to the local to vehicle processing module.

If the received voice data and/or audio data is not in the desired format, the routing module determines how the voice data needs to be reformatted and/or determines how the audio data is to be reformatted. As an example of reformatting voice data, the routing module 458 sends voice data to the digitized voice formatting module 450. The digitized voice formatting module 450 is operable to convert voice data into raw voice data (if needed) and then convert the raw voice data into the desired format for digital voice (if the raw format is not the desired format). Such voice formats include, but are not limited to, 32 Kbps MP3 for speech, 96 Kbps MP3 for speech, 8 Kbps speech codecs, etc.

As an example of reformatting audio data, the routing module 458 sends audio data to the digitized audio formatting module, which is operable to convert audio data into raw audio data (if needed) and then convert the raw audio data (e.g., PCM) into the desired format for digital audio data (if the raw format is not the desired format). Such audio data formats include, but are not limited to, MP3, ACC (advanced audio coding), Ogg Vorbis, FLAC (free lossless audio codec), ALAC (Apple's lossless audio Codec), WAV (waveform audio file), AIFF (audio interchangeable file format), DSD (direct stream digital), etc.

FIG. 26 is a schematic block diagram of an example of incoming video and/or graphics data processing to produce screen-to-screen (STS) formatted inbound signals. This diagram is similar to the diagram of FIG. 20 with the inclusion of further detail of the inbound digital video-graphics processing module 108. The inbound digital video-graphics processing module 108 includes a routing module 470, a digital video formatting module 460, a digital graphics formatting module 462, a digital text formatting module 464, a digital image formatting module 466, a bypass 468, and an output multiplexer.

The routing module 470 receives inbound video-graphics data (e.g., video data, graphics data, image data, and/or text data) and determines whether it should be format processed. For example, the routing module 470 receives a processing instruction regarding the inbound video-graphics data; the processing instruction indicates the type of format processing, if any, and whether multiple format processing steps are needed. As another example, the routing module 470 interprets inbound video-graphics data to determine the type of format processing, if any, and whether multiple format processing steps are needed.

The desired format for video-graphics data is selectable by the personal computing device and/or by the vehicle computing system. If the received video-graphics data is in the desired format, the routing module 470 sends the video-graphics data via the bypass 468 and the multiplexer to the local to vehicle processing module.

If the received video-graphics data is not in the desired format, the routing module determines how the video-graphics data needs to be reformatted. As an example of reformatting video data, the routing module 470 sends video data to the digitized video formatting module 460. The digitized video formatting module 460 is operable to convert video data into raw video data (if needed) and then convert the raw video data into the desired format for digital video (if the raw format is not the desired format). Such video formats include, but are not limited to, MP4, MOV, WMV, AVI, AVCHC, FLV, F4V, SWF, MKV, WEBM, HTML, etc.

As an example of reformatting graphics data, the routing module 470 sends graphics data to the digitized graphics formatting module 462. The digitized graphics formatting module 462 is operable to convert graphics data into raw graphics data (if needed) and then convert the raw graphics data into the desired format for graphics data (if the raw format is not the desired format). Such graphics formats include, but are not limited to, bit map (BMP), TIFF, JPEG, GIF, PNG, etc.

As an example of reformatting text data, the routing module 470 sends image data to the digitized text formatting module 464. The digitized text formatting module 464 is operable to convert text data into raw text data (if needed) and then convert the raw text data into the desired format for text data (if the raw format is not the desired format). Such text formats include, but are not limited to, ASCII, UTF-8, UTF-16, PDF, DOC, RTF, TEX, TXT, etc.

As an example of reformatting image data, the routing module 470 sends image data to the digitized image formatting module 466. The digitized image formatting module 466 is operable to convert image data into raw image data (if needed) and then convert the raw image data into the desired format for image data (if the raw format is not the desired format). Such image formats include, but are not limited to, JPEG, PNG, GIF, TIFF, PSD, PDF, EPS, AI, EPS, etc.

When incoming data has multiple file components (e.g., video, graphics, image, text, etc.) and the components can be separated, the routing module sends the respective file components to the appropriate digital formatting module 460-466. For example, text data is sent to the digitized test formatting module 464 and graphics data is sent to the digitized graphics formatting module 462.

FIG. 27 is a schematic block diagram of an example of outgoing audio data processing from screen-to-screen (STS) formatted outbound signals. This diagram is similar to the diagram of FIG. 21 with the inclusion of further detail of the outbound digital audio processing module 118. The outbound digital audio processing module 118 includes a routing module 458, a digital voice formatting module 450, a digitized audio formatting module 452, a bypass 456, and an output multiplexer. The routing module 458, the digital voice formatting module 450, the digitized audio formatting module 452, the bypass 456, and the output multiplexer operate as previously discussed with reference to FIG. 25 with the exception that, in this embodiment, the modules are operating on outbound voice data and/or outbound audio data.

FIG. 28 is a schematic block diagram of an example of outgoing video and/or graphics data processing from screen-to-screen (STS) formatted outbound signals. This diagram is similar to the diagram of FIG. 21 with the inclusion of further detail of the outbound digital video-graphics processing module 116. The outbound digital video-graphics processing module 116 includes a routing module 470, a digital video formatting module 460, a digital graphics formatting module 462, a digital text formatting module 464, a digital image formatting module 466, a bypass 468, and an output multiplexer. The routing module 470, the digital video formatting module 460, the digital graphics formatting module 462, the digital text formatting module 464, the digital image formatting module 466, the bypass 468, and the output multiplexer operate as previously discussed with reference to FIG. 26 with the exception that, in this embodiment, the modules are operating on outbound video-graphics data.

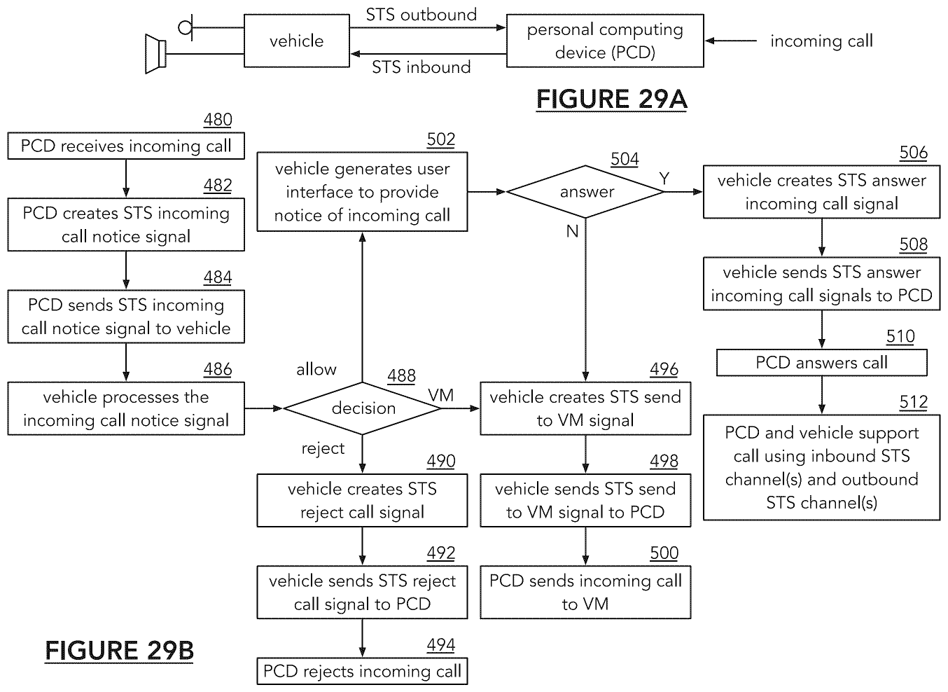

FIG. 29A is a schematic block diagram of an example of screen-to-screen (STS) communications between a vehicle computing system and a personal computing device regarding an incoming call. The incoming call is received by the personal computing device. STS signals from the vehicle to the personal computing device are deemed to be outbound signals and STS signals from the personal computing device to the vehicle are deemed to be inbound signals. The speaker and microphone are the voice output and voice input for the incoming call.

FIG. 29B is a logic diagram of an example of a method for screen-to-screen (STS) communications between a vehicle computing system (VCS) and a personal computing device (PCD) regarding an incoming call. The method begins at step 480 where the PCD receives an incoming call via its communication module (e.g., a cellular incoming call via a cellular RF channel).

The method continues at step 482 where the PCD creates an STS incoming call notice signal as previously discussed. The method continues at step 484 where the PCD sends the STS incoming call signal to the vehicle communication system via a screen-to-screen communication link (e.g., a control channel).

The vehicle computing system processes the incoming call notice signal to determine whether to allow the call, reject the call, or send the call to voice mail (VM). The vehicle computing system renders its decision based on a variety of factors as previously discussed with at least reference to FIGS. 10 and 11. The method continues at step 488 where the vehicle computing device renders its decision.

If the decision is to reject the call, the method continues at step 490 where the vehicle computing system creates an STS reject call signal. The method continues at step 492 where the vehicle computing system sends the STS reject call signal to the personal computing device (PCD). The method continues at step 494 where the personal computing device rejects the incoming call (e.g., does not answer it, stops processing the incoming RF cellular signals, etc.).

If, at step 488, the decision of the vehicle computing system was to send the incoming call to voice mail, the method continues at step 496 where the vehicle computing system creates an STS send to voice mail message. The method continues at step 498 where the vehicle computing system sends the STS send to voice mail message to the personal computing device. The method continues at step 500 where the personal computing device sends the incoming call to voice mail.

If, at step 488, the decision of the vehicle computing system was to allow the incoming call, the method continues at step 502 where the vehicle computing system generates a user interface (e.g., GUI, audible notice, etc.) that provides notice the incoming call (e.g., notice of the call, ID of the caller, etc.) and provides a mechanism for a user input (e.g., touch, voice command, etc.) to answer or not answer the incoming call.

At step 504 the vehicle computing device interprets the user input regarding the incoming call. If the user input indicates that the incoming call is to be rejected (e.g., not answered), the method continues at step 496 where the vehicle computing device creates the STS send to voice mail signal.

If the user input indicates that the incoming call is to be answered, the method continues at step 506 where the vehicle computing system creates an STS answer the incoming call signal. The method continues at step 50-8 where the vehicle computing system sends the STS answer the incoming call signal to the personal computing device. The method continues at step 510 where the personal computing device answers the incoming call. The method continues at step 512 where the personal computing device and the vehicle computing system support the incoming call using one or more inbound STS channels and one or more outbound STS channels.

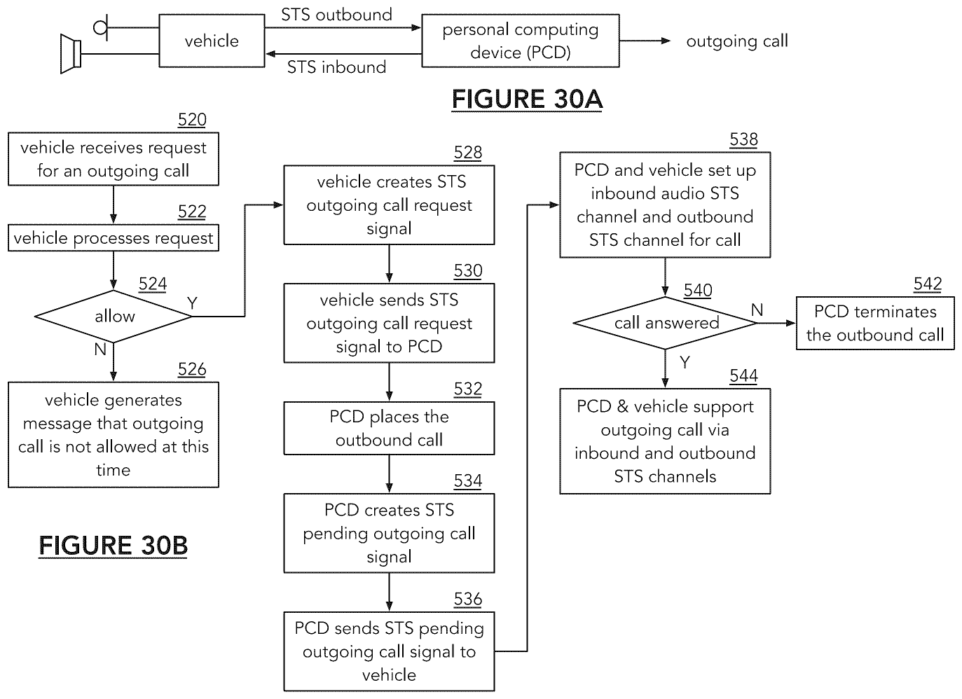

FIG. 30A is a schematic block diagram of an example of screen-to-screen (STS) communications between a vehicle computing system and a personal computing device regarding an outgoing call. The outgoing call is initiated via a user interface of the vehicle computing system. If the vehicle computing system allows the outgoing call, STS signals from the vehicle to the personal computing device are deemed to be outbound signals and STS signals from the personal computing device to the vehicle are deemed to be inbound signals. The speaker and microphone are the voice output and voice input for the outgoing call.

FIG. 30B is a logic diagram of an example of a method for screen-to-screen (STS) communications between a vehicle computing system and a personal computing device regarding an outgoing call. The method begins at step 520 where the vehicle computing system receives a request for an outgoing call via a user interface (e.g., a graphical and/or audible interface). The method continues at step 522 where the vehicle computing system processes the outgoing call request.

The method continues at step 524 where the vehicle computing system renders its decision regarding the outgoing call. The vehicle computing system renders its decision based on a variety of factors as previously discussed with at least reference to FIGS. 10 and 11. If the vehicle computing system does not allow the outgoing call, the method continues at step 526 where the vehicle computing system generates a message (e.g., graphical and/or audible, etc.) that the outgoing call is not allowed at this time.

If the vehicle computing system allows the outgoing call, the method continues at step 528 where the vehicle computing system creates an STS outgoing call request signal, which includes the phone number of the party being call. The method continues at step 530 where the vehicle computing system sends the STS outgoing call request signal to the personal computing device (PCD).

The method continues at step 532 where the personal computing device places the outgoing call. The method continues at step 534 where the personal computing device creates an STS pending outgoing call signal. The method continues at step 536 where the personal computing device sends the STS pending outgoing call signal to the vehicle computing system. The vehicle computing system creates a graphical and/or audible user notice of the pending outgoing call.

The method continues at step 538 where the personal computing device and the vehicle computing system set up inbound and outbound STS channels to support the outgoing call. The method continues at step 540 where the personal computing device determines whether the outgoing call has been answered (e.g., by the person being call or by voice mail). If not, the method continues at step 542 where the personal computing device terminates the outgoing call and releases the STS inbound and outbound channels for the outgoing call. If the outgoing call is answered, the method continues at step 544 where the personal computing device and the vehicle computing system support the outgoing call via the STS inbound and outbound channels.

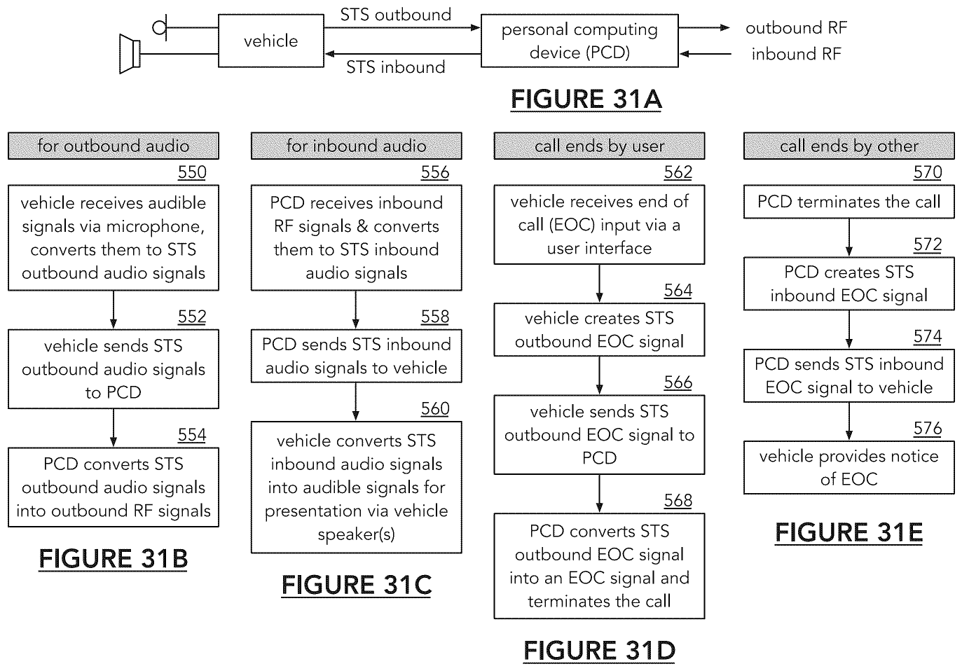

FIG. 31A is a schematic block diagram of an example of screen-to-screen (STS) communications between a vehicle computing system and a personal computing device supporting an incoming and/or an outgoing call. For outgoing voice signals, the microphone of the vehicle receives audible signals, which are processed by the vehicle computing system to produce outbound STS signals that are sent to the personal computing device. The personal computing device transmits the outgoing audible signals as outbound RF signals.

The personal computing device receives inbound RF signals and converts them into baseband audio signals. The personal computing device further processes the audio signals to produce inbound STS signals. The vehicle computing system recovers the audio signals from the inbound STS signals. The speakers of the vehicle render the audio signals audible.

FIGS. 31B-31E are logic diagrams of examples of methods for supporting screen-to-screen (STS) communications between a vehicle computing system and a personal computing device regarding an incoming call and/or an outgoing call. FIG. 31B is a method for processing outbound audio that begins at step 550 where the vehicle receives audible signals via the microphone, which are converted into digital audio signals and/or digital voice signals. The vehicle computing device converts the digital audio signals and/or digital voice signals into STS outbound audio signals.

The method continues at step 552 where the vehicle computing system sends the STS outbound audio signals to the personal computing device. The method continues at step 554 where the personal computing device converts the STS outbound audio signals into outbound RF signals.

FIG. 31C is a method for processing inbound audio that begins at step 556 where the personal computing device receives inbound RF signals and converts them into STS inbound audio signals. The method continues at step 558 where the personal computing device sends the STS inbound audio signals to the vehicle computing system. The method continues at step 560 where the vehicle computing system converts the STS inbound audio signals into audible signals for presentation via the vehicle's speaker(s).

FIG. 31D is a method for processing the end of call as initiated by the occupant in the vehicle (e.g., the user). The method begins at step 562 where the vehicle computing system receives an end of call (EOC) input via a user interface. The method continues at step 564 where the vehicle computing system creates an STS outbound EOC signal. The method continues at step 566 where the vehicle computing system sends the STS outbound EOC signal to the personal computing device. The method continues at step 568 where the personal computing device recovers the EOC signal and terminates the call and the inbound and outbound STS channels are released.

FIG. 31E is a method for processing the end of call as initiated by the other party (i.e., not the occupant or user in the vehicle). The method begins at step 570 where the personal computing device terminates the call. The method continues at step 572 where the personal computing device creates an STS inbound end of call (EOC) signal. The method continues at step 574 where the personal computing device sends the STS inbound EOC signal to the vehicle computing system.

The method continues at step 576 where the vehicle computing system provides notice of the end of the call. In addition, the inbound and outbound STS channels are released.

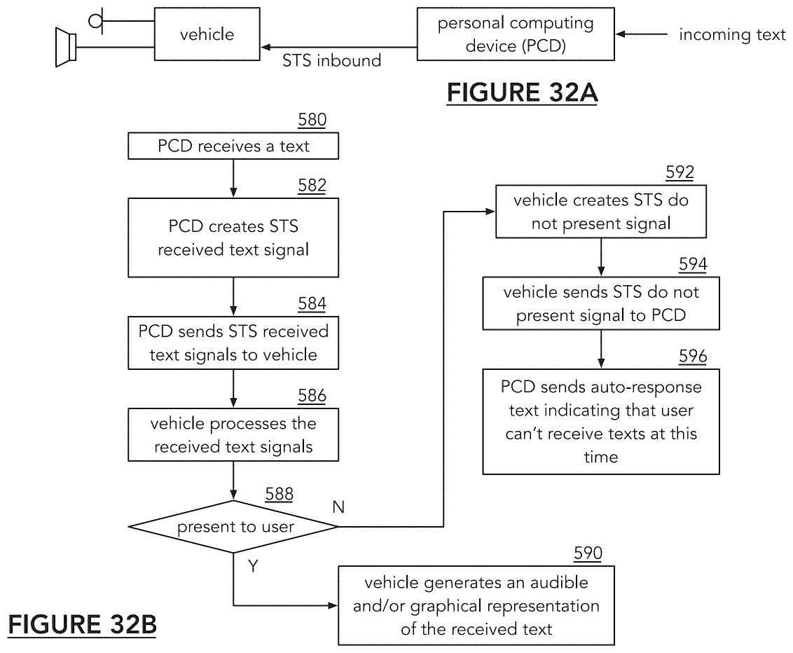

FIG. 32A is a schematic block diagram of an example of screen-to-screen (STS) communications between a vehicle computing system and a personal computing device regarding an incoming text. The incoming text is received by the personal computing device via an RF signal., which notifies the vehicle computing system of the text. If allowed, the vehicle computing system presents the text to an occupant of the vehicle via a graphics and/or audible representation.

FIG. 32B is a logic diagram of an example of a method for screen-to-screen (STS) communications between a vehicle computing system and a personal computing device regarding an incoming text. The method begins at step 580 where the personal computing device receives an incoming text via an RF signal.

The method continues at step 582 where the personal computing device creates an STS received text signal. In one embodiment, the STS received text signal includes a notice of the incoming text. In another embodiment, the STS received text signal includes the text message.

The method continues at step 584 where the personal computing device sends the STS received text signal to the vehicle computing system. The method continues at step 586 where the vehicle computing system processes the STS received text signal, which includes determining whether to present the text to the user (e.g., an occupant of the vehicle). If the STS received text signal is a notice of the incoming text, the processing further includes setting up an inbound STS channel receive the text from the personal computing device.

The vehicle computing system renders its decision at step 588. If the decision is to present the text to the user, the method continues at step 590 where the vehicle computing system generates an audible and/or graphical representation of the received text. If the user desires to respond to the text, it is treated as an outgoing text.

If the decision is to not present the text to the user, the method continues at step 592 where the vehicle computing system creates an STS do not present signal and sends it to the personal computing device at step 594. The method continues at step 596 where the personal computing device sends an auto-response text to originator of the incoming text indicating that the user cannot receive texts at this time.

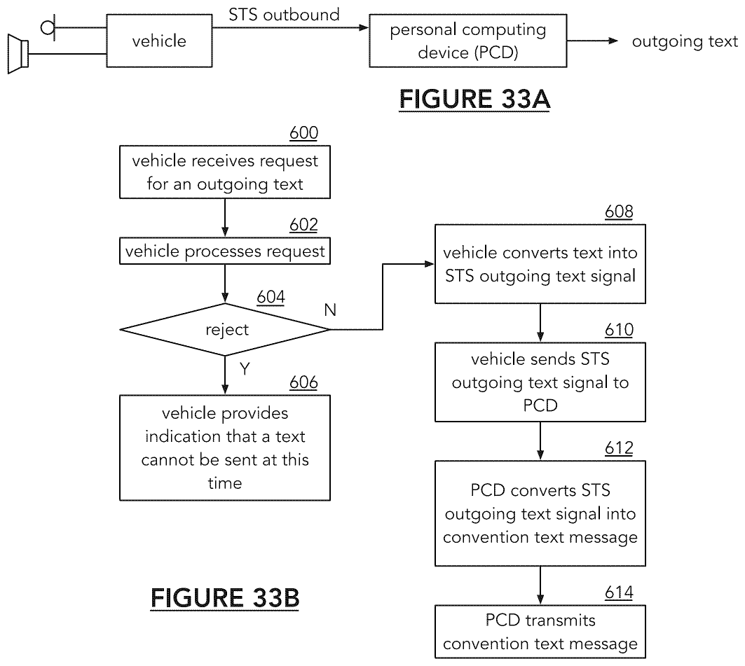

FIG. 33A is a schematic block diagram of an example of screen-to-screen (STS) communications between a vehicle computing system and a personal computing device regarding an outgoing text. The outgoing text is originated by a user (i.e., an occupant of the vehicle) via a user interface provided by the vehicle computing device. The outgoing text is sent to the personal computing device via an outbound STS communication. The personal computing device processes the outgoing text to produce and transmit an outbound RF signal that includes the text.

FIG. 33B is a logic diagram of an example of a method for screen-to-screen (STS) communications between a vehicle computing system and a personal computing device regarding an outgoing text. The method begins at step 600 where the vehicle computing system receives a request for an outgoing text. The request is received via an audible and/or graphics user interface provided by the vehicle computing system.

The method continues at step 602 where the vehicle computing device processes the request, which includes determining whether to allow the user to send an outgoing text. The decision may further factor in the target of the outgoing text and/or whether the outgoing text is a response to a received incoming text. The method continues at step 604 where the vehicle computing system renders its decision. Examples of reasons to allow or reject a request were provided with reference to FIGS. 10 and 11.

If the decision was to reject the request, the method continues at step 606 where the vehicle computing system provides an indication to the user that a text cannot be sent at this time. If the decision was to allow the request, the method continues at step 608 where the vehicle computing system obtains the content of the text message (if it does not already have it) and converts the text message into an STS outgoing text signal.

The method continues at step 610 where the vehicle computing system sends the STS outgoing text signal to the personal computing device. The method continues at step 612 where the personal computing device converts the STS outgoing text signal into a conventional text message. The method continues at step 614 where the personal computing device transmits the conventional text message as an outbound RF signal to the targeted destination.

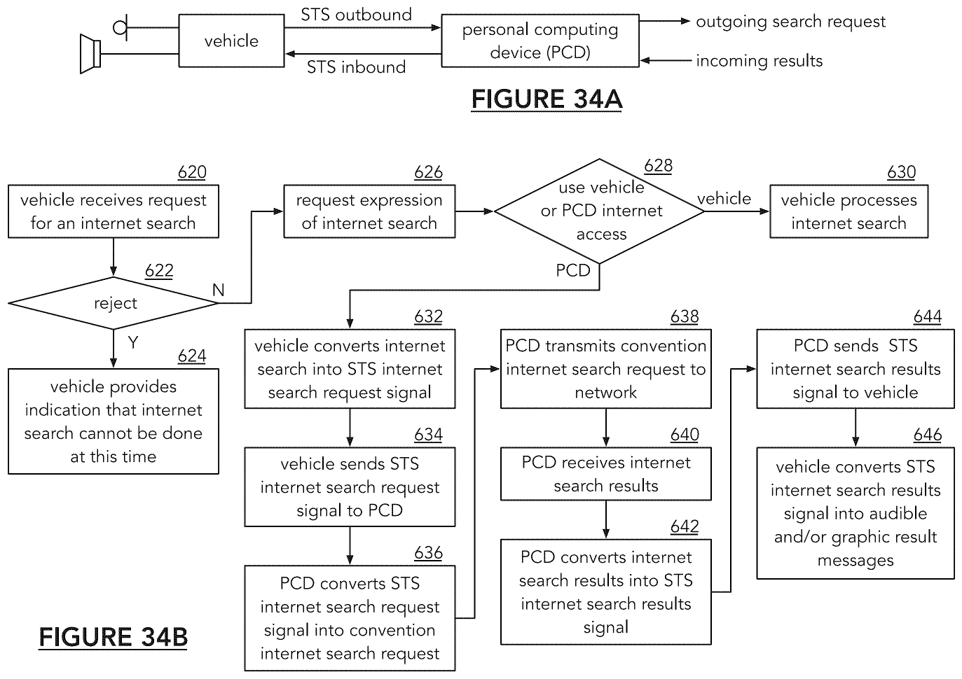

FIG. 34A is a schematic block diagram of an example of screen-to-screen (STS) communications between a vehicle computing system and a personal computing device regarding an outgoing internet search request. A search request is initiating by a user in the vehicle, the vehicle sends the search request to the personal computing device via an outbound STS communication. The personal computing device transmits the request and receives incoming results. The personal computing device sends the incoming results to the vehicle computing system via an inbound STS communication.

FIG. 34B is a logic diagram of an example of a method for screen-to-screen (STS) communications between a vehicle computing system and a personal computing device regarding an outgoing internet search request. The method begins at step 620 where the vehicle computing system receives a request for an internet search via an audible and/or graphical user interface in the vehicle. The method continues at step 622 where the vehicle computing system determines whether to reject the request. Examples of reasons to allow or reject a request were provided with reference to FIGS. 10 and 11.

If the decision is to reject the request, the method continues at step 624 where the vehicle computing system provides an audible and/or visual indication to the user that an internet search cannot be done at this time. If the decision is to allow the request, the method continues at step 626 where the vehicle computing system requests an expression of the internet search. For example, the vehicle computing systems provides an audible message for the user to verbally describe what is to be searched via the internet.

The method continues at step 628 where the vehicle computing system determines whether to use its internet searching capabilities and/or to use the personal computing device's internet searching capabilities. If the vehicle computing system decides to use its internet searching capabilities, the method continues at step 630 where the vehicle computing system processes the internet search and provides the user with the results.

If the vehicle computing system decides to use the personal computing device's internet searching capabilities, the method continues at step 632 where the vehicle computing system converts the internet search into an STS internet search request signal. The method continues at step 634 where the vehicle computing system sends the STS internet search request signal to the personal computing device.

The method continues at step 636 where the personal computing device converts the STS internet search request signal into a conventional search request (i.e., conventional with respect to the personal computing device). The method continues at step 638 where the personal computing device transmits the conventional search request to a network. The method continues at step 640 where the personal computing device receives internet search results.

The method continues at step 642 where the personal computing device converts the internet search results into STS internet search results signal and sends it to the vehicle computing system in step 644. The method continues at step 646 where the vehicle computing system converts the STS internet search results signal into audible and/or graphical internet search message for presentation to the user.

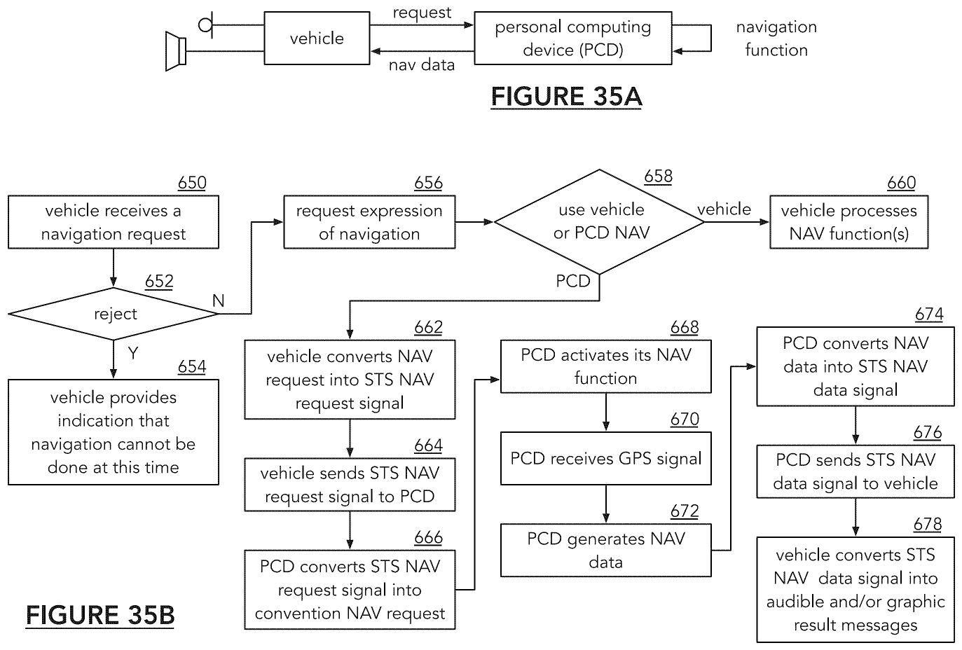

FIG. 35A is a schematic block diagram of an example of screen-to-screen (STS) communications between a vehicle computing system and a personal computing device regarding an outgoing navigation function request. Navigation requests are sent to the personal computing device and resulting navigation data is sent to the vehicle computing system.

FIG. 35B is a logic diagram of an example of a method for screen-to-screen (STS) communications between a vehicle computing system and a personal computing device regarding an outgoing navigation function request. The method begins at step 650 where the vehicle computing system receives a navigation request (e.g., directions to a destination, find landmarks, change view, etc.) via an audible and/or graphical user interface in the vehicle. The method continues at step 652 where the vehicle computing system determines whether to reject the request. Examples of reasons to allow or reject a request were provided with reference to FIGS. 10 and 11.

If the decision is to reject the request, the method continues at step 654 where the vehicle computing system provides an audible and/or visual indication to the user that the requested navigation request cannot be done at this time. If the decision is to allow the request, the method continues at step 656 where the vehicle computing system requests an expression of the navigation request. For example, the vehicle computing systems provides an audible message for the user to verbally describe the desired navigation function.

The method continues at step 658 where the vehicle computing system determines whether to use its navigation program and/or to use the personal computing device's navigation program. If the vehicle computing system decides to use its own navigation program, the method continues at step 660 where the vehicle computing system processes the navigation request and provides the user with the results.

If the vehicle computing system decides to use the personal computing device's navigation program, the method continues at step 662 where the vehicle computing system converts the navigation request into an STS navigation request signal. The method continues at step 664 where the vehicle computing system sends the STS navigation request signal to the personal computing device.

The method continues at step 666 where the personal computing device converts the STS navigation request signal into a conventional navigation request (i.e., conventional with respect to the personal computing device). The method continues at step 668 where the personal computing device activates its navigation program (if not already active). The method continues at step 670 where the personal computing device receives GPS signals. The method continues at step 672 where the personal computing device generates navigation data based on the request.

The method continues at step 674 where the personal computing device converts the navigation data into STS navigation data signal and sends it to the vehicle computing system in step 676. The method continues at step 678 where the vehicle computing system converts the STS navigation data signal into audible and/or graphical navigation results for presentation to the user.

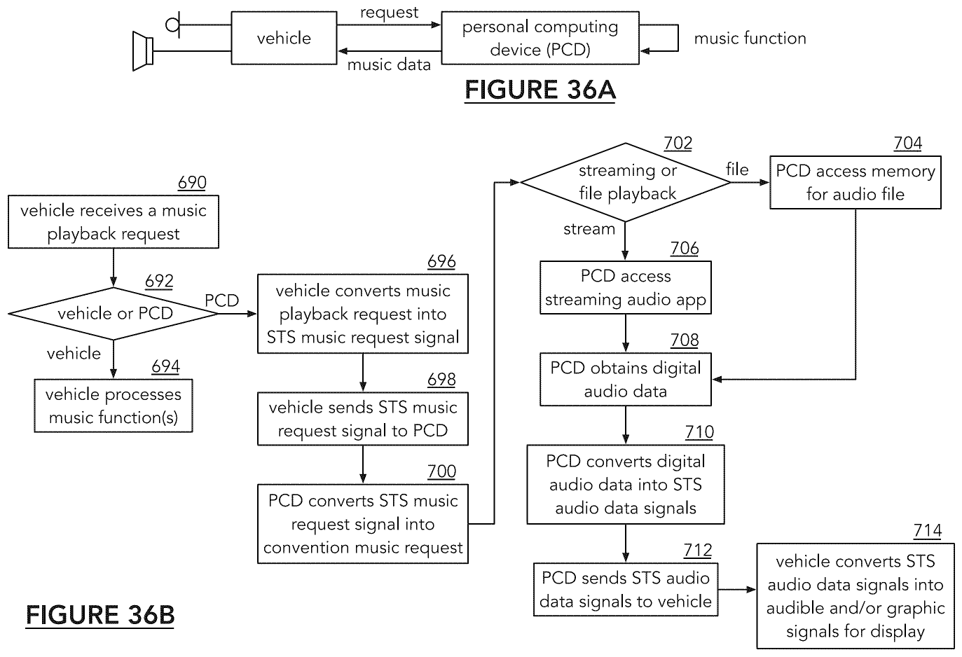

FIG. 36A is a schematic block diagram of an example of screen-to-screen (STS) communications between a vehicle computing system and a personal computing device regarding a music playback request. Music playback requests are sent to the personal computing device and retrieved music data is sent to the vehicle computing system.

FIG. 36B is a logic diagram of an example of a method for screen-to-screen (STS) communications between a vehicle computing system and a personal computing device regarding a music playback request. The method begins at step 690 where the vehicle computing system receives a music playback request. The method continues at step 692 where the vehicle computing system determines whether to service the playback request using one of its music playback programs or using one of the personal computing device's music playback programs. For example, the request indicates a particular program of the personal computing device.

If the decision is to use one of the vehicle computing system's music playback programs, the method continues at step 694 where the vehicle computing system processes the music playback request. If the decision is to use one of the personal computing device's music playback programs, the method continues at step 696 where the vehicle computing system converts the music playback request into an STS music request signal.

The method continues at step 698 where the vehicle computing system sends the STS music request signal to the personal computing device. The method continues at step 700 where the personal computing device converts the STS music request signal into a conventional music playback request for a particular music playback program. The method continues at step 702 where the personal computing device determines whether the targeted program is a file playback program or a streaming audio program.

For a file playback program, the method continues at step 704 where the personal computing device engages the targeted file playback application and accesses a desired audio file from memory. The method continues at step 708, discussed below.

For a streaming audio playback program, the method continues at step 706 where the personal computing device engages the targeted streaming audio playback application. The method continues at step 708 where the personal computing device obtains digital audio data from the targeted playback program.

The method continues at step 710 where the personal computing device converts the digital audio data into STS audio data signals and sends them to the vehicle computing system at step 712. The method continues at step 714 where the vehicle computing system converts the STS audio data signals into audible signals, which may include graphical information regarding the audio data, and presents the audible signals and the graphical information to the user.

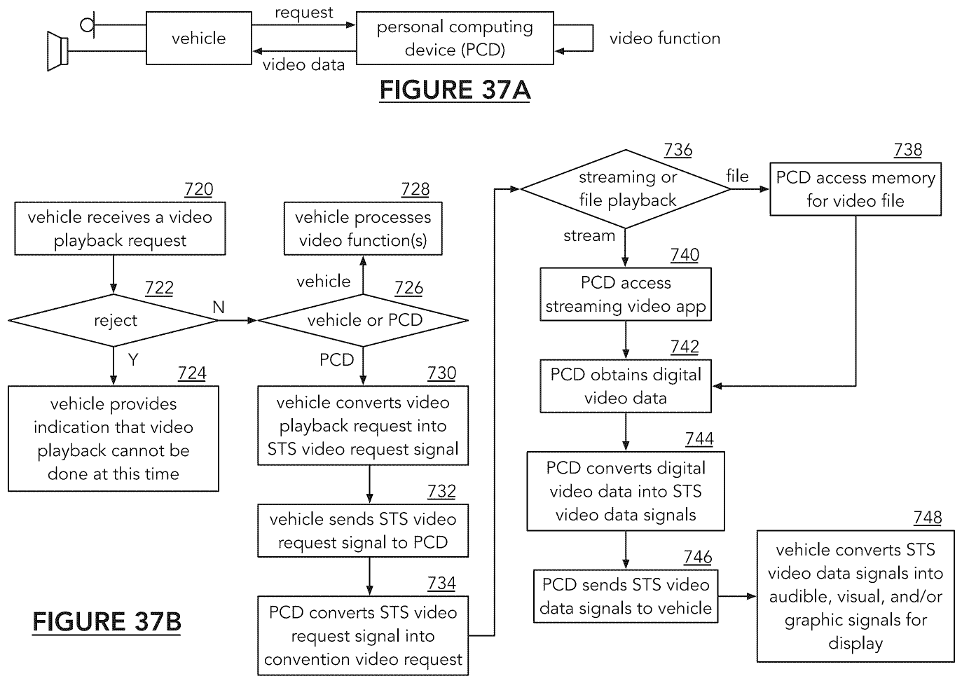

FIG. 37A is a schematic block diagram of an example of screen-to-screen (STS) communications between a vehicle computing system and a personal computing device regarding a video playback request. Video playback requests are sent to the personal computing device and retrieved video data is sent to the vehicle computing system.

FIG. 37B is a logic diagram of an example of a method for screen-to-screen (STS) communications between a vehicle computing system and a personal computing device regarding a video playback request. The video playback may be for one of a variety of visual data programs. For example, the playback request is to display a stored video file, a stored image file, a stored graphics file, a stored text file, and/or a combination thereof. As another example, the playback request is to display streaming video, which may include images, graphics, and/or text. As a further example, the playback request is for a video game (stored and/or streaming).

The method begins at step 720 where the vehicle computing system receives a video playback request. The method continues at step 722 where the vehicle computing system determines whether to allow or reject the video playback request. Examples of reasons to allow or reject a request were provided with reference to FIGS. 10 and 11.

If the decision is to reject the request, the method continues at step 724 where the vehicle computing system provides an indication that video playback cannot be done at this time. If the decision is to allow the request, the method continues at step 726 where the vehicle computing system determines whether to service the playback request using one of its video playback programs or using one of the personal computing device's video playback programs. For example, the request indicates a particular program of the personal computing device.

If the decision is to use one of the vehicle computing system's video playback programs, the method continues at step 728 where the vehicle computing system processes the video playback request. If the decision is to use one of the personal computing device's video playback programs, the method continues at step 730 where the vehicle computing system converts the video playback request into an STS video request signal.

The method continues at step 732 where the vehicle computing system sends the STS video request signal to the personal computing device. The method continues at step 734 where the personal computing device converts the STS video request signal into a conventional video playback request for a particular video playback program. The method continues at step 736 where the personal computing device determines whether the targeted program is a video file playback program or a streaming video program.

For a video file playback program, the method continues at step 738 where the personal computing device engages the targeted video file playback application and accesses a desired video file from memory. The method continues at step 742, discussed below.

For a streaming video playback program, the method continues at step 740 where the personal computing device engages the targeted streaming video playback application. The method continues at step 742 where the personal computing device obtains digital video data from the targeted playback program.

The method continues at step 744 where the personal computing device converts the digital video data into STS video data signals and sends them to the vehicle computing system at step 746. The method continues at step 748 where the vehicle computing system converts the STS video data signals into audible signals and visual signals, which are presented to the user presents the audible signals and the graphical information to the user.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/−1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While transistors may be shown in one or more of the above-described figure(s) as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

As applicable, one or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition—requires “artificial” intelligence—i.e., machine/non-human intelligence.

As applicable, one or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

As applicable, one or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

As applicable, one or more functions associated with the methods and/or processes described herein can be implemented in a system that is operable to electronically store digital data in a memory device. Such storage cannot practically be performed by the human mind because the human mind is not equipped to electronically store digital data.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method comprises:
establishing, by a vehicle computing system, a screen-to-screen (STS) communication link with a personal computing device;
detecting, by the vehicle computing system, a requested operation of the personal computing device;
determining, by the vehicle computing system, whether the requested operation is allowed based on one or more of: operational status of the vehicle, a type of the requested operation, and targeted vehicle occupant;
when the requested operation is allowed, establishing, by the vehicle computing system, one or more of: one or more inbound STS channels for inbound STS signals and one or more outbound STS channels for outbound STS signals; and
facilitating, by the vehicle computing system, the requested operation via the one or more of: the one or more inbound STS channels and the one or more outbound STS channels.

2. The method of claim 1, wherein the STS communication link comprises:
e-field signaling between a VCS sensor of the vehicle computing system (VCS) and a PCD sensor of the personal computing device (PCD).

3. The method of claim 2, wherein the establishing the STS communication link comprises:
transmitting, by the vehicle computing system, a detection signal via the VCS sensor, wherein the detection signal includes an oscillating component at a first frequency;
receiving, by the vehicle computing system, an ACK signal via the VCS sensor, wherein the personal computing device transmitted the ACK signal via the PCD sensor; and
establishing, by the vehicle computing system, a control channel with the personal computing system, wherein the control channel utilizes control channel signaling at a particular frequency.

4. The method of claim 3 further comprises at least one of:
the particular frequency being substantially equal to the first frequency; and
the particular frequency is a second frequency.

5. The method of claim 1, wherein the detecting the requested operation comprises:
receiving, by the vehicle computing device, a notice of an incoming operation via a control channel with the personal computing device.

6. The method of claim 1, wherein the detecting the requested operation comprises:
providing, by the vehicle computing device, a user interface that provides a list of outgoing operations associated with the personal computing device; and
receiving, by the vehicle computing device, an input via the user interface, wherein the input indicates selection of an outgoing operation from the list of outgoing operations.

7. The method of claim 1, wherein the determining whether the requested operation is allowed comprises:
determining operational status of the vehicle as being one of: driving, at rest, in park, or off;
determining the type of the requested operation as being one of: incoming call, outgoing call, incoming text, outgoing text, outgoing navigation request, outgoing data search request, playback of an audio file, playback of a video file, activate a video game, or other application on the personal computing device; and
determining the targeted vehicle occupant as the driver, a front seat passenger, or a rear seat passenger.

8. The method of claim 7 further comprises:
determining, for the driver, that the requested operation is allowed when the requested operation can be primarily performed by the driver in a hands-free mode.

9. The method of claim 1, wherein the facilitating the requested operation comprises:
for an incoming call or an outgoing call:
establishing the one or more inbound STS channels for inbound voice signals from the personal computing device; and
establishing the one or more outbound STS channels for outbound voice signals to the personal computing device.

10. The method of claim 1, wherein the facilitating the requested operation comprises:
for an incoming text, establishing the one or more inbound STS channels for inbound text data signals from the personal computing device.

11. The method of claim 1, wherein the facilitating the requested operation comprises:
for an outgoing text, establishing the one or more outbound STS channels for outbound text data to the personal computing device.

12. A computer readable memory device comprises:
a first memory section that stores operational instructions that, when read by a vehicle computing system, causes the vehicle computing system to:
establish a screen-to-screen (STS) communication link with a personal computing device;
detect a requested operation of the personal computing device; and
determine whether the requested operation is allowed based on one or more of: operational status of the vehicle, a type of the requested operation, and targeted vehicle occupant;
a second memory section that stores operational instructions that, when read by the vehicle computing system, causes the vehicle computing system to:
when the requested operation is allowed, establish one or more of: one or more inbound STS channels for inbound STS signals and one or more outbound STS channels for outbound STS signals; and
facilitate the requested operation via the one or more of: the one or more inbound STS channels and the one or more outbound STS channels.

13. The computer readable memory device of claim 12, wherein the STS communication link comprises:
e-field signaling between a VCS sensor of the vehicle computing system (VCS) and a PCD sensor of the personal computing device (PCD).

14. The computer readable memory device of claim 13, wherein the first memory section further stores operational instructions that, when read by the vehicle computing system, causes the vehicle computing system to establish the STS communication link by:
transmitting a detection signal via the VCS sensor, wherein the detection signal includes an oscillating component at a first frequency;
receiving an ACK signal via the VCS sensor, wherein the personal computing device transmitted the ACK signal via the PCD sensor; and
establishing a control channel with the personal computing system, wherein the control channel utilizes control channel signaling at a particular frequency.

15. The computer readable memory device of claim 14 further comprises at least one of:
the particular frequency being substantially equal to the first frequency; and
the particular frequency is a second frequency.

16. The computer readable memory device of claim 12, wherein the first memory section further stores operational instructions that, when read by the vehicle computing system, causes the vehicle computing system to detect the requested operation by:
receiving a notice of an incoming operation via a control channel with the personal computing device.

17. The computer readable memory device of claim 12, wherein the first memory section further stores operational instructions that, when read by the vehicle computing system, causes the vehicle computing system to detect the requested operation by:
providing a user interface that provides a list of outgoing operations associated with the personal computing device; and
receiving an input via the user interface, wherein the input indicates selection of an outgoing operation from the list of outgoing operations.

18. The computer readable memory device of claim 12, wherein the first memory section further stores operational instructions that, when read by the vehicle computing system, causes the vehicle computing system to determine whether the requested operation is allowed by:
determining operational status of the vehicle as being one of: driving, at rest, in park, or off;
determining the type of the requested operation as being one of: incoming call, outgoing call, incoming text, outgoing text, outgoing navigation request, outgoing data search request, playback of an audio file, playback of a video file, activate a video game, or other application on the personal computing device; and
determining the targeted vehicle occupant as the driver, a front seat passenger, or a rear seat passenger.

19. The computer readable memory device of claim 18, wherein the first memory section further stores operational instructions that, when read by the vehicle computing system, causes the vehicle computing system to:
determine, for the driver, that the requested operation is allowed when the requested operation can be primarily performed by the driver in a hands-free mode.

20. The computer readable memory device of claim 12, wherein the second memory section further stores operational instructions that, when read by the vehicle computing system, causes the vehicle computing system to facilitate the requested operation by:
for an incoming call or an outgoing call:
establishing the one or more inbound STS channels for inbound voice signals from the personal computing device; and
establishing the one or more outbound STS channels for outbound voice signals to the personal computing device.

21. The computer readable memory device of claim 12, wherein the second memory section further stores operational instructions that, when read by the vehicle computing system, causes the vehicle computing system to facilitate the requested operation by:
for an incoming text, establishing the one or more inbound STS channels for inbound text data signals from the personal computing device.

22. The computer readable memory device of claim 12, wherein the second memory section further stores operational instructions that, when read by the vehicle computing system, causes the vehicle computing system to facilitate the requested operation by:
for an outgoing text, establishing the one or more outbound STS channels for outbound text data to the personal computing device.
